(19) United States
(12) Patent Application Publication
(10) Pub. No.: US 2025/0124295 A1
(43) Pub. Date: Apr. 17, 2025

(54) BRANCHED MACHINE-LEARNING TRAINING ARCHITECTURES FOR MULTI-PHASE MODEL TRAINING

(71) Applicant: Optum, Inc., Minnetonka, MN (US)

(72) Inventors: Kaustav MUKHERJEE, Kolkata (IN); Sumeet Shivshankar SHAHU, Navi Mumbai (IN); Deepak CHANDRASEKAR, Bengaluru (IN); Manish CHOPRA, Gurgaon (IN); Daksh PEEPAT, New Delhi (IN); Abhishek MAZUMDER, New Delhi (IN)

(21) Appl. No.: 18/485,848

(22) Filed: Oct. 12, 2023

(51) Int. Cl. G06N 3/09; G06F 40/166; G06F 40/289; G06F 40/35; G06F 40/40; G06N 3/0455

(52) U.S. Cl. CPC G06N 3/09; G06F 40/166; G06F 40/289; G06F 40/35; G06F 40/40; G06N 3/0455

(57) ABSTRACT

Various embodiments of the present disclosure provide machine learning training techniques for implementing a multi-phase training process to holistically train a machine learning summarization model. The multi-phase training process may include generating, using the machine learning summarization model, a training summary for a training transcript. A first, second, and/or a third reward metric may be generated based on the training summary. Each reward metric may be tailored to a different aspect of the machine learning summarization model. For example, the first reward may be based on a comparison between the training summary and a target summary corresponding to the training transcript. The second reward may be based on the training summary and a positive/negative summary. The third reward may be based on training key phrases from the training summary. The model may be trained by optimizing an aggregated reward metric derived from the first, second, and/or third reward metrics.

### BACKGROUND

Various embodiments of the present disclosure address technical challenges related to computer-based text interpretation and summarization. Existing techniques for interpreting and summarizing transcripts, such as real-world dialogues, pose technical challenges that are amplified by dialog length. So much so that traditional transformer-based pretrained models impose input limits that reduce the applicability of such models for long form dialogs. Other technical challenges are related to the context-dependent nature of some transcripts that prevent traditional machine learning approaches from accurately deciphering the semantic meaning of the transcript. Even if the semantic meaning is accurately deciphered, contemporary abstractive summarization models introduce hallucinations in the form of garbage character/words or out of context information that may change the meaning of a summary for transcript.

Some traditional models are trained on data with long transcript size and short summary sized datasets which lead to incomplete summaries with missing information. Some techniques leverage loss functions that historically miss important aspects, such as key words or phrases, related to a transcript as during the loss calculation or metric calculation an entire sentence is considered which leads to overlapping stop-words or unimportant words that inflate the summary at the expense of the important aspects. Techniques with increased accuracy require a large memory footprint that makes them unsuitable for real-time inferencing. For example, existing language models that are deployed for real-time inferencing are held back by increased high latency due to data preprocessing and model inferencing times. Moreover, some language models use maximum likelihood estimation (MLE) based training for fine-tuning downstream tasks. Such training techniques have multiple drawbacks including (1) “exposure bias” when the model expects gold-standard data at each step during training but does not have such supervision when testing, and (2) “representational collapse” due to the degradation of generalizable representations of pre-trained models during the fine-tuning stage. Various embodiments of the present disclosure make important contributions to various existing machine learning training and summarization techniques by addressing each of these technical challenges.

### BRIEF SUMMARY

Various embodiments of the present disclosure disclose a multi-phase training process for training improved machine learning models to improve upon traditional computer interpretability and summarization techniques. The multi-phase training process includes an initialization phase and a training phase. During an initialization phase, a machine learning model is initialized for particular prediction domain by generating an initial weight set through a plurality of initialization operations. By initializing the machine learning model before a training phase of the multi-phase training process, some techniques of the present disclosure enable a model to identify contextual attributes that are specific to a prediction domain while optimizing the model for the prediction domain. The model is optimized by generating an optimized weight set through one or more training operations of a training phase. During the training phase, the multi-phase training process leverages reinforcement learning to optimize the machine learning model using an aggregated reward metric. The aggregated reward metric is generated using three different rewards that are each individually tailored to a performance deficiencies (e.g., hallucination, missing key features, etc.) prevalent with conventional machine learning summarization models. In this manner, using some of the techniques described herein, a multi-phase training process may be performed to optimize a machine learning model to overcome technical disadvantages of traditional models thereby improving upon the accuracy, availability, and granularity of existing text interpretation techniques, while reducing time and processing resources consumed by such techniques.

In some embodiments, a computer-implemented method includes generating, by one or more processors and using a machine learning model, a training summary for a training transcript; generating, by the one or more processors, a first reward metric for the machine learning model based on a comparison between the training summary and a target summary corresponding to the training transcript; generating, by the one or more processors, a second reward metric for the machine learning model based on the training summary, a positive summary, and a negative summary; generating, by the one or more processors, a third reward metric for the machine learning model based on one or more training key phrases from the training summary; generating, by the one or more processors, an aggregated reward metric based on one or more of the first reward metric, the second reward metric, or the third reward metric; and initiating, by the one or more processors, the performance of one or more training operations for the machine learning model based on the aggregated reward metric.

In some embodiments, a computing system includes a memory and one or more processors communicatively coupled to the memory, the one or more processors are configured to generate, using a machine learning model, a training summary for a training transcript; generate a first reward metric for the machine learning model based on a comparison between the training summary and a target summary corresponding to the training transcript; generate a second reward metric for the machine learning model based on the training summary, a positive summary, and a negative summary; generate a third reward metric for the machine learning model based on one or more training key phrases from the training summary; generate aggregated reward metric based on one or more of the first reward metric, the second reward metric, or the third reward metric; and initiate the performance of one or more training operations for the machine learning model based on the aggregated reward metric.

In some embodiments, one or more non-transitory computer-readable storage media include instructions that, when executed by one or more processors, cause the one or more processors to generate, using a machine learning model, a training summary for a training transcript; generate a first reward metric for the machine learning model based on a comparison between the training summary and a target summary corresponding to the training transcript; generate a second reward metric for the machine learning model based on the training summary, a positive summary, and a negative summary; generate a third reward metric for the machine learning model based on one or more training key phrases from the training summary; generate aggregated reward metric based on one or more of the first reward metric, the second reward metric, or the third reward metric; and initiate the performance of one or more training operations for the machine learning model based on the aggregated reward metric.

### BRIEF DESCRIPTION OF DRAWINGS

FIG. 1 illustrates an example computing system in accordance with one or more embodiments of the present disclosure.

FIG. 2 is a schematic diagram showing a system computing architecture in accordance with some embodiments discussed herein.

FIG. 3 provides a dataflow diagram showing an example multi-phase training process in accordance with some embodiments discussed herein.

FIG. 4 provides a dataflow diagram showing an example initialization phase of the multi-phase training process in accordance with some embodiments discussed herein.

FIG. 5 provides a dataflow diagram showing an example training phase of the multi-phase training process in accordance with some embodiments discussed herein.

FIG. 6 provides a dataflow diagram showing an example operation of a contrastive module in accordance with some embodiments discussed herein.

FIG. 7 provides a dataflow diagram showing an example operation of a trained machine learning summarization model in accordance with some embodiments discussed herein.

FIG. 8 is a flowchart showing an example of a process for initializing a machine learning summarization model in accordance with some embodiments discussed herein.

FIG. 9 is a flowchart showing an example of a process for generating an initial weight set for a machine learning model in accordance with some embodiments discussed herein.

FIG. 10 is a flowchart showing an example of a process for generating an optimized weight set for a machine learning model in accordance with some embodiments discussed herein.

FIG. 11 is a flowchart showing an example of a process for generating a contrastive reward in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout. Moreover, while certain embodiments of the present disclosure are described with reference to predictive data analysis, one of ordinary skills in the art will recognize that the disclosed concepts can be used to perform other types of data analysis.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

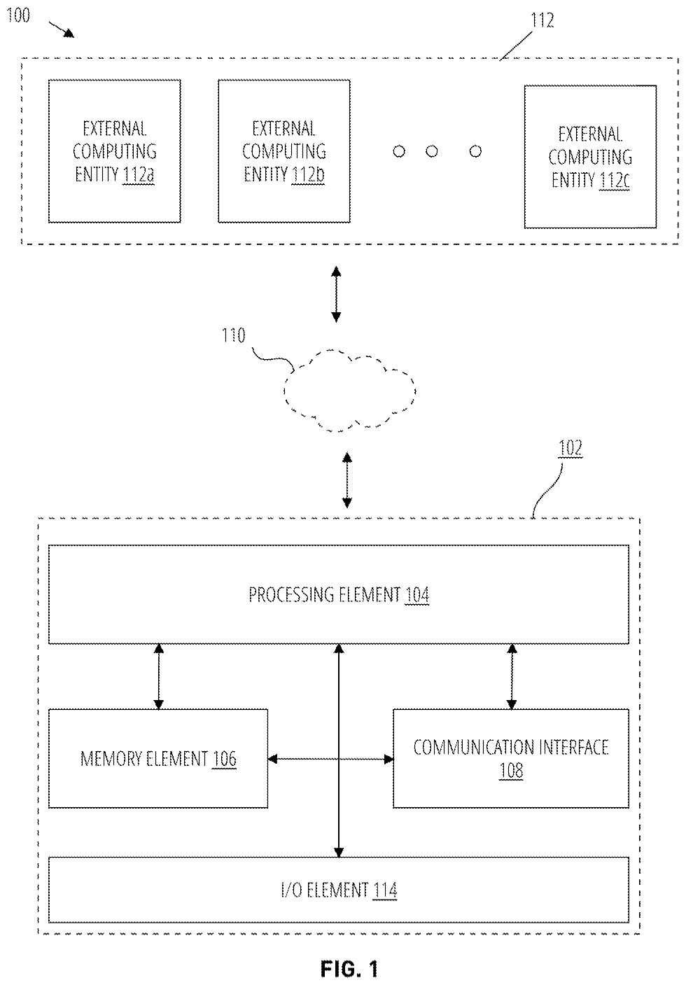

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., training techniques, summarization techniques, data processing techniques, and/or the like) described herein.

The external computing entities 112a-c, for example, may include and/or be associated with one or more entities that may be configured to receive, store, manage, and/or facilitate datasets that include transcripts, text sequences, and/or the like. The external computing entities 112a-c may provide the training data to the predictive computing entity 102 which may leverage the training data to generate a training dataset. By way of example, the predictive computing entity 102 may include a machine learning training system that is configured to leverage transcripts, textual data, and/or other forms of data (e.g., audio transcripts, etc.) corresponding to a prediction domain to generate a training dataset and/or train a machine learning model using the training dataset. In some examples, this may include the aggregation of data from across the external computing entities 112a-c into one comprehensive training dataset. The external computing entities 112a-c, for example, may be associated with one or more data repositories, cloud platforms, compute nodes, organizations, and/or the like, that may be individually and/or collectively leveraged by the predictive computing entity 102 to obtain and aggregate data for a prediction domain.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like, may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

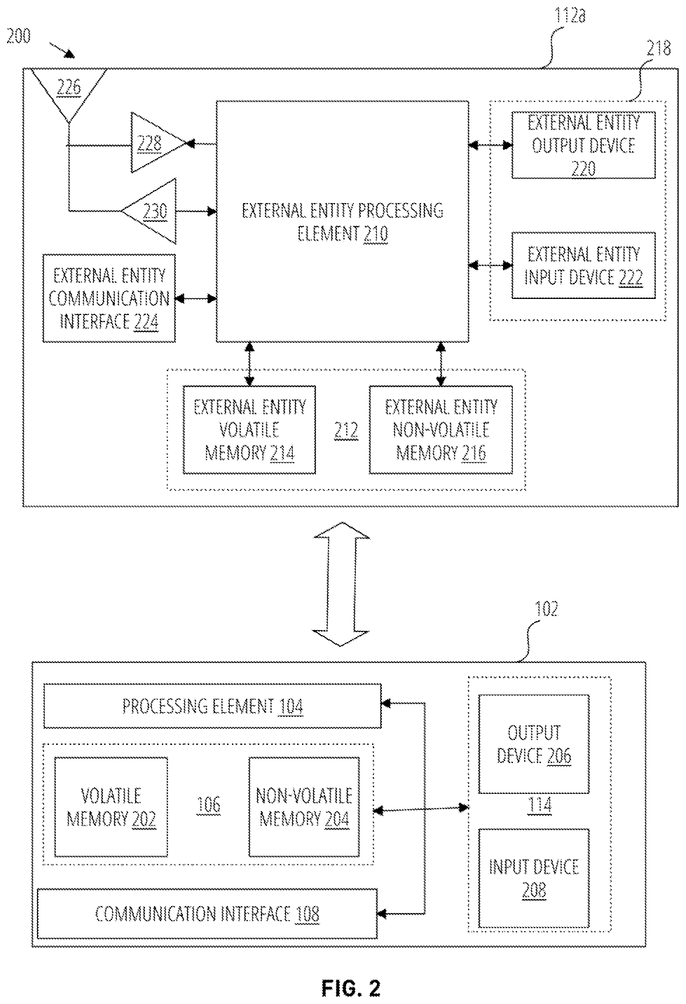

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more steps/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

The predictive computing entity 102 may be embodied by a computer program product includes non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Examples of Certain Terms

In some embodiments, the term “machine learning summarization model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning summarization model may include one or more machine learning models configured, trained (e.g., jointly, separately, etc.), and/or the like to generate a summary from a transcript. The machine learning summarization model may include one or more of any type of machine learning model including one or more supervised, unsupervised, semi-supervised, reinforcement learning models, and/or the like. In some examples, the machine learning summarization model may include multiple models configured to perform one or more different stages of a summarization process.

In some embodiments, a machine learning summarization model is trained, using one or more of the training techniques of the present disclosure, to generate an abstractive summary of a long form transcript, such as a long form dialog, conversation, and/or the like. In this regard, a machine learning summarization model may use a sliding window for handling long length transcripts. A machine learning summarization model may include any combination of machine learning architectures. In some examples, a machine learning summarization model may include an encode-decoder framework followed by a language model. For example, a machine learning summarization model may include a transformer encoder with sliding window based attention. In addition, or alternatively, the machine learning summarization model may include a transformer decoder. In addition, or alternatively, the machine learning summarization model may include a language model, such as a fine-tuned language model (e.g., tuned using one or more techniques of the present disclosure).

In some embodiments, the term “transcript” refers to a data entity that describes natural language text. A transcript may include a natural language document, phrase, record, and/or any other representation of natural language. A transcript may include a written sequence of sentences, such as a paper, a presentation, a book, and/or the like. In addition, or alternatively, a transcript may include a recorded verbal sequence of utterances, such as a dialog transcription. A dialog transcription, for example, may describe a temporal flow of verbal interactions between one or more interaction participants. For instance, a dialog transcription may include a plurality of utterances, each descriptive of a verbal interaction between the one or more interaction participants. An example of a dialog transcription is a call transcript between one or more participants of a call, such as a call transcript for a call between a customer service agent and a customer. In the noted example, the call transcript may describe verbal interactions by the participants in a temporally sequential manner, where each verbal interaction by a participant may include one or more utterances (e.g., each including one or more sentences). For example, with respect to the call transcript for a call between a customer service agent and a customer, the call transcript may describe that a first utterance by the customer service agent (e.g., “Hello, how is your day today. How may I help you?”) is temporally followed by a second utterance by the customer (e.g., “Thank you. I'm doing well. I am trying to check my account balance.”), which may then be temporally followed by a third utterance by the customer service agent, and so on. Other example transcripts may include meeting transcripts, conference call transcripts, auction transcripts, chat-bot transcripts, and/or the like.

In some embodiments, the term “transcript summary” refers to one or more summary sentences for a transcript that are generated using abstractive summarization techniques. A transcript summary for a transcript may deviate from the exact language of the transcript. For example, the transcript summary may include a meaningful summary based on the important sentences, utterances, and/or the like from the transcript. A transcript summary may include a plurality of summary sentences that summarize the important aspects of a transcript. The plurality of summary sentences may include new sentences that are generated by rephrasing and/or augmenting sentences and/or utterances from the transcript with new words. In some embodiments, a transcript summary is generated for a transcript using a machine learning summarization model that is trained to summarize transcripts for a prediction domain.

In some embodiments, the term “prediction domain” refers to an environment associated with a plurality of transcripts. A prediction domain may include domain data that is based on and/or tailored to one or more aspects of an environment. For instance, a prediction domain may include a clinical domain that includes a plurality of clinical transcripts associated with a clinical environment (e.g., call transcripts for a clinical call center, medical research documentation, clinical visit records, etc.). As another example, a prediction domain may include a particular entity domain that includes a plurality of transcripts associated with a particular entity environment, such as an organizational environment, business environment, and/or the like. By way of example, a prediction domain may include a particular business domain that includes a plurality of transcripts corresponding to a business entity. In some examples, the plurality of transcripts may form at least a portion of a training dataset for training a machine learning model to generate summaries that are tailored to a particular prediction domain.

In some embodiments, the term “training dataset” refers to domain data for a particular prediction domain. A training dataset may include a plurality of training transcripts and/or target summaries respectively corresponding to the training transcripts. For example, the training dataset may include a labeled training dataset with a plurality of transcript data objects. Each transcript data object may include a training transcript and a target summary, one or more example summaries, and/or a target topic for the training transcript. The one or more example summaries may include a positive and/or negative summary for a training transcript.

In some examples, the training dataset may include a key-phrase dataset. A key-phrase dataset may include a plurality of key phrases, each indicative of a historical and/or designated utterance, phrase, sentence, and/or any other keyword or sequence of one or more keywords corresponding to a prediction domain.

In some embodiments, the term “training transcript” refers to a transcript included in a training dataset for a prediction domain.

In some embodiments, the term “target summary” refers to a ground truth summary for a training transcript. A target summary may be descriptive of a desired summary for a corresponding transcript. A target summary may include a plurality of target summary sentences that are descriptive of one or more important aspects of a corresponding transcript. A respective target summary may be manually generated and/or automatically generated using one or more summarization techniques.

In some embodiments, the term “positive summary” refers to a positive training sample for a training summary. In some examples, the positive training sample may include a paraphrased target summary for a training transcript. A positive summary may be leveraged to generate a reward for a machine learning model based on a comparison between the positive summary and a summary output by the machine learning model.

In some embodiments, the term “negative summary” refers to a negative training sample for a training summary. In some examples, the negative training sample may include a paraphrased target summary for a training transcript that is augmented to remove and/or change one or more key words, phrases, and/or the like to degrade the quality of the paraphrased target summary. A negative summary may be leveraged to generate a penalty for a machine learning model based on a comparison between the negative summary and a summary output by the machine learning model.

In some embodiments, the term “target topic classification” refers to a ground truth topic classification for a training transcript.

In some embodiments, the term “initialization operation” refers to an iteration of an initialization phase of a multi-phase training process for a machine learning summarization model. An initialization operation may include initializing a machine learning summarization model by generating and/or updating an initial weight set for the machine learning summarization model. The initial weight set, for example, may include one or more weighted parameters for one or more portions of the machine learning summarization model. For instance, an initial weight set may include one or more weighted parameters for an encoder and/or decoder portion of the machine learning summarization model. An initialization operation may include generating and/or updating the initial weight set using one or more supervised training techniques, such as backpropagation of errors to optimize a loss metric. In some examples, the loss metric may include an aggregated initialization loss generated using a machine learning initialization model.

In some embodiments, the term “machine learning initialization model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning initialization model may include one or more machine learning models configured, trained (e.g., jointly, separately, etc.), and/or the like to generate one or more training outputs for generating an initial weight set for a machine learning model. The machine learning initialization model may include one or more of any type of machine learning model including one or more supervised, unsupervised, semi-supervised, reinforcement learning models, and/or the like. In some examples, the machine learning initialization model may include multiple models configured to perform one or more different stages of an initialization phase of a multi-phase training process.

In some embodiments, the machine learning initialization model includes one or more neural networks. For example, the machine learning initialization model may include a branched neural network architecture that includes one or more branches, or modules. The branched neural network architecture, for example, may include a branched network architecture with three branches. The first branch may include a summarization module, such as a machine learning summarization model described herein. The second branch may include topic classification module, such as a transformer-based classification module. The third branch may include a key-phrase module.

The summarization module may be configured to generate and/or output an initializing summary during an iteration of an initialization phase of a machine learning summarization model. The topic classification module may be configured to generate and/or output a topic classification corresponding to a summary, such as an initializing summary and/or a corresponding target summary during an iteration of an initialization phase of a machine learning summarization model. The key-phrase module may be configured to generate and/or output one or more key phrases corresponding to a summary, such as an initializing summary and/or a corresponding target summary during an iteration of an initialization phase of a machine learning summarization model.

In some examples, the second and third branches may include pretrained neural networks with a plurality of frozen weights, respectively, during an initialization phase of a machine learning summarization model. The first branch may include a modifiable weight set that may be modified to generate an initial weight set for the machine learning summarization model. The initial weight set may be trained using supervised learning (e.g., backpropagation of errors, etc.) with a loss minimization function configured to minimize an aggregated initialization loss derived from a weighted sum of a summarization loss, a topic loss, and/or a key-phrase loss.

In some embodiments, the term “summarization loss” refers to a data entity that describes a first initialization loss metric for a machine learning model, such as a machine learning summarization model. A summarization loss may be based on a comparison between (i) an initializing summary generated by a first branch (e.g., at least a portion of a machine learning summarization model) of the machine learning initialization model for an initializing transcript and (ii) an initializing target summary for the initializing transcript. An initializing transcript and/or initializing target summary may correspond to a transcript data object of a training dataset.

In some embodiments, a summarization loss includes a supervised loss metric for a machine learning summarization model. A summarization loss, for example, may include a mean square error, quadratic, and/or L2 loss. In addition, or alternatively, a summarization loss may include a mean absolute error and/or L1 loss. In some examples, a summarization loss may include a log-Cosh loss and/or quantile loss.

In some embodiments, the term “topic loss” refers to a data entity that describes a second initialization loss metric for a machine learning model, such as a machine learning summarization model. A topic loss may be based on a comparison between (i) a first topic classification generated by a second branch (e.g., a pretrained topic classification module) of the machine learning initialization model for an initializing summary and (ii) a second topic classification for an initializing target summary corresponding to the initializing transcript. In some embodiments, a topic loss may be indicative of a supervised loss metric for the machine learning summarization model, such as a classification loss function including binary cross-entropy loss, log loss, hinge loss, and/or the like.

In some embodiments, the term “key-phrase loss” refers to a data entity that describes a third initialization loss metric for a machine learning model, such as a machine learning summarization model. A key-phrase loss may be based on a comparison between one or more key phrases extracted from an initializing summary by a third branch (e.g., the key-phrase module 412) of the machine learning initialization model and a key-phrase dataset. In some embodiments, a key-phrase loss may be indicative of a supervised loss metric for the machine learning summarization model, such as a named entity recognition loss, and/or the like.

In some embodiments, the term “aggregated initialization loss” refers to a data entity that describes a total loss metric for a machine learning model, such as a machine learning summarization model. An aggregated initialization loss may include a weighted sum of a summarization loss, topic loss, and/or key-phrase loss.

In some embodiments, the term “initial weight set” refers to a data entity that describes one or more weighted parameters for a machine learning model. In some examples, an initial weight set includes one or more weighted parameters for at least a portion of a machine learning summarization model. By way of example, an initial weight set may include one or more weighted parameters for an encoding and/or decoding transformer of a machine learning summarization model.

In some embodiments, the term “training operation” refers to an iteration of a training phase of a multi-phase training process for a machine learning summarization model.

A training operation may include training a machine learning summarization model by generating and/or updating an optimized weight set for the machine learning summarization model. The optimized weight set, for example, may include one or more weighted parameters for one or more portions of the machine learning summarization model. For instance, an optimized weight set may include one or more weighted parameters for an encoder, decoder, and/or language model portion of a machine learning summarization model. A training operation may include generating and/or updating the optimized weight set using one or more reinforcement learning training techniques, such as agent-based reinforcement learning using a reward metric. In some examples, the reward metric may include an aggregated reward metric generated using a machine learning training model.

In some embodiments, the term “machine learning training model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning training model may include one or more machine learning models configured, trained (e.g., jointly, separately, etc.), and/or the like to generate one or more training outputs for generating an optimized weight set for a machine learning model. The machine learning training model may include one or more of any type of machine learning model including one or more supervised, unsupervised, semi-supervised, reinforcement learning models, and/or the like. In some examples, the machine learning training model may include multiple models configured to perform one or more different stages of a training process.

In some embodiments, the machine learning training model includes one or more neural networks. For example, the machine learning training model may include a branched neural network architecture that includes one or more branches, or modules. The branched neural network architecture, for example, may include a branched network architecture with three branches. A first branch may include a summarization module, such as a machine learning summarization model described herein. A second branch may include a contrastive module and a third branch may include a key-phrase reward module.

The summarization module may be configured to generate and/or output a training summary during an iteration of a training phase of a machine learning summarization model. The contrastive module may be configured to generate and/or output a contrastive reward corresponding to the training summary. The key-phrase reward module may be configured to generate and/or output a key-phrase reward corresponding to a training summary.

In some examples, the second and third branches may include pretrained neural networks with a plurality of frozen weights, respectively, during a training phase of a machine learning summarization model. The first branch may include a modifiable weight set that may be modified to generate an optimized weight set for a machine learning summarization model. For example, the machine learning summarization model may be preloaded with fine-tuned weights (e.g., initial weight set) generated during an initialization phase of a multi-phase training process. The optimized weight set may be trained using reinforcement learning using a reinforcement learning agent configured to optimize an aggregate reward function derived from a weighted sum of a summarization reward, a contrastive reward, and/or a key-phrase reward.

In some embodiments, the term “summarization reward” refers to a data entity that describes a first reward metric for a machine learning model, such as a machine learning summarization model. A summarization reward may be based on a comparison between a training summary and a target summary corresponding to the training summary. A training summary, for example, may be generated by a first branch (e.g., at least a portion of a machine learning summarization model) of the machine learning training model for a training transcript. A target summary may be from a transcript data object of a training dataset that corresponds to the training transcript.

In some embodiments, a summarization reward is generated based on one or more discrete probability distributions. For example, a summarization reward may be based on a distance (e.g., inverse Fisher-Rao Distance, etc.) between a first probability distribution for a training summary and a second probability distribution for a target summary. Each probability distribution, for example, may include an inverse document frequency distribution, such as a discrete probability distribution over masked tokens for a masked summaries generated from a training and target summary, respectively.

In some embodiments, the term “contrastive reward” refers to a data entity that describes a second reward metric for a machine learning model, such as a machine learning summarization model. A contrastive reward may be based on a training summary, a positive summary, and/or a negative summary. In some examples, a contrastive reward may be generated using a contrastive module based on a weighted aggregation of a sentence-level reward and a masked language model reward.

In some embodiments, the term “contrastive module” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The contrastive module may include one or more machine learning models configured, trained (e.g., jointly, separately, etc.), and/or the like to generate contrastive reward for a machine learning model. The contrastive module may include one or more of any type of machine learning model including one or more supervised, unsupervised, semi-supervised, reinforcement learning models, and/or the like. In some examples, the contrastive module may include multiple models configured to perform one or more different stages of an evaluation process. The one or more models, for example, may include a machine learning sentence-level transformer and/or a machine learning masked language model.

In some embodiments, the term “machine learning sentence-level transformer” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning sentence-level transformer may include a transformer model, such as a bidirectional encoder representations from transformers (BERT) model that may be previously finetuned for a prediction domain using a training dataset. The machine learning sentence-level transformer may be configured to generate a plurality of embeddings for one or more input summaries.

In some embodiments, the term “embedding” refers to data entity that describes an embedding for an input summary. An embedding, for example, may include a text embedding including a real-valued vector that encodes one or more attributes for an input summary. An embedding may include a training embedding generated for a training summary, a positive embedding generated for a positive summary, and/or a negative embedding generated for a negative summary.

In some embodiments, the term “sentence-level reward” refers to a data entity that describes a portion of a second reward metric for a machine learning model, such as a machine learning summarization model. A sentence-level reward, for example, may include a portion of a contrastive reward. A sentence-level reward may be based on a plurality of embeddings generated by a machine learning sentence-level transformer. For example, a plurality of embeddings may include a training embedding, a positive embedding, and/or a negative embedding. In some examples, a sentence-level reward may include a distance between each of the training, positive, and/or a negative embeddings. By way of example, the sentence-level reward may include a cosine similarity distance between the plurality of embeddings. In this manner, the sentence-level reward may ensure that global level features and/or lexical similarities are captured which can mitigate sentence level hallucination problems, such as grammatical mistakes, structural issues, out of context sentences, and/or the like.

In some embodiments, the term “machine learning masked language model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A machine learning masked language model, for example, may include BERT-based masked language model that may be previously finetuned for a prediction domain using a training dataset. A machine learning masked language model may be configured to generate a plurality of masked summaries for one or more input summaries and output a discrete probability distribution of masked tokens for each of the masked summaries.

In some embodiments, the term “masked language model reward” refers to a data entity that describes a portion of a second reward metric for a machine learning model, such as a machine learning summarization model. A masked language model reward, for example, may include a portion of a contrastive reward. A masked language model reward may be based on a plurality of discrete probability distributions generated by a machine learning masked language model. A plurality of discrete probability distributions, for example, may include a training distribution generated for a training summary, a positive distribution generated for a positive summary, and/or a negative distribution generated for a negative summary. Each discrete probability distribution may include a distribution of masked tokens passed through an inverse document frequency such that one or more key words of the distribution receive a higher weightage than the common words like stop-words or irrelevant words. The masked language model reward may include a distance (e.g., a Fisher-Rao Distance, etc.) between the training distribution, the positive distribution, and/or the negative distribution. The masked language model reward may enable a non-parametric way to replace word/token level hallucination in the form of garbage words, out of context words, word spelling errors, singular/plural features, and/or the like.

In some embodiments, the term “key-phrase reward” refers to a data entity that describes a third reward metric for a machine learning model, such as a machine learning summarization model. A key-phrase reward may be based on one or more training key phrases from a training summary. A key-phrase reward may be based on a comparison between one or more key phrase extracted from a training and target summary, respectively. For example, a key-phrase reward may include a distance, such as a word mover's distance, a cosine distance, and/or the like, that is indicative of a similarity between the key phrases extracted for the training and target summaries.

In some embodiments, the term “aggregated reward metric” refers to a data entity that describes a total reward metric for a machine learning model, such as a machine learning summarization model. An aggregated reward metric may include a weighted sum of a summarization reward, contrastive reward, and/or key-phrase reward.

In some embodiments, the term “optimized weight set” refers to a data entity that describes one or more weighted parameters for a machine learning model. In some examples, an optimized weight set includes one or more weighted parameters for at least a portion of a machine learning summarization model.

### IV. Overview, Technical Improvements, and Technical Advantages

Embodiments of the present disclosure present training techniques that improve computer interpretation and summarization of transcripts, including long, unstructured dialogs, using abstractive summarization models. To do so, the present disclosure provides multi-phase training techniques that leverage branched neural networks to incrementally initialize and then optimize model weights for machine learning summarization model. Each branched neural network leverages a combination of loss and/or reward functions to generate aggregated training metrics that holistically account for deficiencies that plague traditional abstractive summarization techniques, such as hallucination inefficiencies, synonym problems, exposure bias, representational collapse, among others. Some embodiments of the present disclosure provide two different branched neural architectures that may be used in series and/or independently to improve traditional machine learning model by (i) initializing traditional models for a prediction domain and/or (ii) optimizing traditional models for the prediction domain through reinforcement learning using a holistic reward metric. In this way, the present disclosure provides improved machine learning models and methods for implementing improved machine learning models that improve upon conventional abstractive summarization techniques.

Some embodiments of the present disclosure enable the initialization of a machine learning model for a new prediction domain. To do so, some embodiments of the present disclosure provide a branched initialization neural architecture, a machine learning initialization model, and supervised learning loss function for generating an initial weight set of a machine learning model that is tailored to a particular prediction domain. The model architecture includes a branched neural architecture that include three different modules, each configured to generate a loss metric tailored to a particular aspect of the machine leaning model. The first module includes a summarization module for which an initial weight set is generated. The second and third modules include pretrained transforms configured to augment a traditional loss function with additional loss metrics tied to the topic and key phrases of a summary. The summary may be trained using the augmented loss function and using supervised learning with a loss minimization objective. In each training iteration after the summarizer module generates a summary the summary is fed to the other 2 modules which may carry out a topic classification and/or key-phrase extraction on the generated summary to generate an aggregate loss that accounts for multiple different aspects of the summary. By doing so, a machine learning model may be initialized quickly to adapt to any new domain it encounters. Such techniques may be implemented with any traditional machine learning technique to initial a model's weight before they are optimized for a prediction domain. This, in turn, improves the training time and reduces computing resources needed for optimizing the machine learning model, while ensuring that the model learns relationships that are not tainted by previous prediction domain.

Some embodiments of the present disclosure enable the improved optimization of a machine learning model for a prediction domain through reinforcement learning. To do so, some embodiments of the present disclosure provide a branched training neural architecture, a machine learning training model, and reinforcement learning agent for generating an optimized weight set of a machine learning model that is tailored to a particular prediction domain. The branched neural architecture may include three different modules including a summarization module (e.g., preloaded with an initial weight set if used in series with the machine learning initialization model) that is trained through reinforcement learning. A second module and third module may include complementary modules that each generate a reward metric for the summarization module. The second module, for example, may include a contrastive module that may use a weighted sum of multiple rewards to mitigate hallucination and/or other degradations of abstractive summarization models. The third module may include of key-phrase reward module which may be fine-tuned on domain data to reward abstractive summaries based on the presence key concepts from an input transcript. The outputs of each of the modules may be leveraged to generate an aggregate reward that accounts for multiple different aspects of an abstractive summary. By doing so, a machine learning model may be optimized to holistically account for different aspects of a desirable summary including accuracy (e.g., minimal hallucinations), completeness (e.g., presence of key concepts), length, etc.

Some embodiments of the present disclosure enable improved reinforcement learning approached that leverage multiple reward metrics. For instance, one reward metric may include a key-phrase reward that may be generated using a key-phrase reward module of the machine learning training model. The key-phrase reward module may individually output extracted sets of key-phrases from generated and ground-truth summaries, respectively. After that distance may be calculated between the two sets of key-phrases to generate a key-phrase reward that may identify the essential information from the summary.

The key-phrase reward may be combined with another reward metric, a contrastive reward, that is defined by a composition of a string-based metric and embedding based reward. Using a hybrid of string-based metric and embedding based reward helps in capturing both the lexical and semantic features of the summaries which provides a better divergence metric due to the use of embedding and flow function. In some examples, the contrastive reward may be leveraged as a maximization objective for reinforcement learning as compared to other contemporary methods where contrastive loss is calculated and used as a minimization objective for supervised learning. Moreover, in some examples, the key-phrase reward and the contrastive reward may be further combined with a summarization reward generated using the function Fisher-Rao Distance between an inverse document frequency of a discrete probability distribution over masked tokens of generated and target summaries. By doing so, the resulting aggregate reward function may account for the true distance between summaries, while considering other aspects of a desirable summary.

Examples of inventive and technologically advantageous embodiments of the present disclosure include: (i) a machine learning initialization model for adapting a model from one prediction domain to another; (ii) a machine learning training model for holistically optimizing a model for a prediction domain; (iii) a contrastive reward and reward module for mitigating detrimental hallucinations in abstractive summaries; and (iv) a multi-phase training process among other aspects of the present disclosure.

### V. Example System Operations

As indicated, various embodiments of the present disclosure make important technical contributions to machine learning technology. In particular, systems and methods are disclosed herein that implement machine learning training techniques and machine learning models for generating abstractive summaries of long transcripts. Unlike traditional training techniques, the machine learning techniques of the present disclosure leverage a multi-phase training process for first initializing and then optimizing a machine learning model for a particular prediction domain. As described herein, each phase of the multi-phase training process leverages holistic training metrics that anticipate and correct for machine learning deficiencies prevalent in traditional abstractive models.

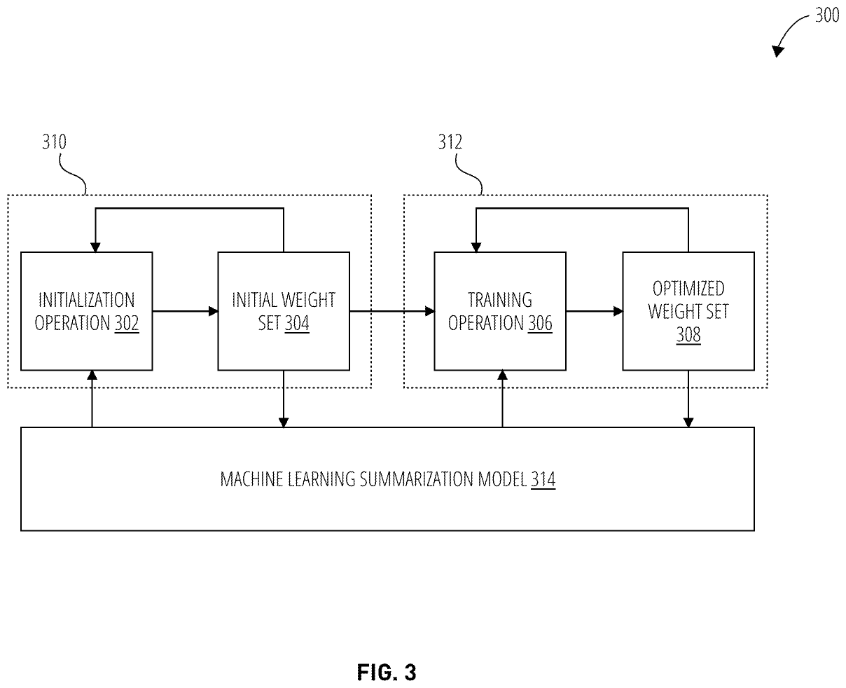

FIG. 3 provides a dataflow diagram showing an example multi-phase training process 300 in accordance with some embodiments discussed herein. The multi-stage training process may include one or more steps, phases, and/or the like, for training a machine learning summarization model 314. The machine learning summarization model 314, for example, may be trained over one or more phases including an initialization phase 310 and/or a training phase 312. By using both an initialization phase 310 and training phase 312, the multi-phase training process 300 helps initialize model weights quicker for domain adaptation as well as produce highly informed summaries detailed with key-phrases by modelling non-differentiable metrics as reward functions.

In some embodiments, the machine learning summarization model 314 is data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning summarization model 314 may include one or more machine learning models configured, trained (e.g., jointly, separately, etc.), and/or the like to generate a summary from a transcript. The machine learning summarization model 314 may include one or more of any type of machine learning model including one or more supervised, unsupervised, semi-supervised, reinforcement learning models, and/or the like. In some examples, the machine learning summarization model 314 may include multiple models configured to perform one or more different stages of a summarization process.

In some embodiments, the machine learning summarization model 314 is trained, using one or more of the training techniques of the present disclosure, to generate an abstractive summary of a long form transcript, such as a long form dialog, conversation, and/or the like. In this regard, the machine learning summarization model 314 may use a sliding window for handling long length transcripts. The machine learning summarization model 314 may include any combination of machine learning architectures. In some examples, the machine learning summarization model 314 may include an encode-decoder framework followed by a language model. For example, the machine learning summarization model 314 may include a transformer encoder with sliding window based attention. In addition, or alternatively, the machine learning summarization model 314 may include a transformer decoder. In addition, or alternatively, the machine learning summarization model 314 may include a language model, such as a fine-tuned language model (e.g., tuned using one or more techniques of the present disclosure).

In some embodiments, a transcript is a data entity that describes natural language text. A transcript may include a natural language document, phrase, record, and/or any other representation of natural language. A transcript may include a written sequence of sentences, such as a paper, a presentation, a book, and/or the like. In addition, or alternatively, a transcript may include a recorded verbal sequence of utterances, such as a dialog transcription (e.g., generated using one or more automated speech to text techniques, etc.). A dialog transcription, for example, may describe a temporal flow of verbal interactions between one or more interaction participants. For instance, a dialog transcription may include a plurality of utterances, each descriptive of a verbal interaction between the one or more interaction participants.

An example of a dialog transcription is a call transcript between one or more participants of a call, such as a call transcript for a call between a customer service agent and a customer. In the noted example, the call transcript may describe verbal interactions by the participants in a temporally sequential manner, where each verbal interaction by a participant may include one or more utterances (e.g., each including one or more sentences). For example, with respect to the call transcript for a call between a customer service agent and a customer, the call transcript may describe that a first utterance by the customer service agent (e.g., “Hello, how is your day today. How may I help you?”) is temporally followed by a second utterance by the customer (e.g., “Thank you. I'm doing well. I am trying to check my account balance.”), which may then be temporally followed by a third utterance by the customer service agent, and so on. Other example transcripts may include meeting transcripts, conference call transcripts, auction transcripts, chat-bot transcripts, and/or the like.

In some embodiments, a transcript summary includes one or more summary sentences for a transcript that are generated using abstractive summarization techniques. A transcript summary for a transcript may deviate from the exact language of the transcript. For example, the transcript summary may include a meaningful summary based on the important sentences, utterances, and/or the like from the transcript. A transcript summary may include a plurality of summary sentences that summarize the important aspects of a transcript. The plurality of summary sentences may include new sentences that are generated by rephrasing and/or augmenting sentences and/or utterances from the transcript with new words. In some embodiments, a transcript summary is generated for a transcript using the machine learning summarization model 314 that is trained to summarize transcripts for a prediction domain.

The initialization phase 310 may include a plurality of initialization iterations. Each iteration may include an initialization operation 302 during which an initial weight set 304 for the machine learning summarization model 314 is generated and/or refined to initialize the machine learning summarization model 314 for a particular prediction domain. By way of example, the machine learning model is previously trained for a first prediction domain. The initial weight set 304 may be configured to initialize the machine learning summarization model 314 for a second prediction domain different from the first prediction domain. As described herein, each initialization operation 302 may leverage an initializing transcript of a plurality of initializing transcripts for a training dataset that corresponds to the second prediction domain.

In some embodiments, a prediction domain is an environment associated with a plurality of transcripts. A prediction domain may include domain data that is based on and/or tailored to one or more aspects of an environment. For instance, a prediction domain may include a clinical domain that includes a plurality of clinical transcripts associated with a clinical environment (e.g., call transcripts for a clinical call center, medical research documentation, clinical visit records, etc.). As another example, a prediction domain may include a particular entity domain that includes a plurality of transcripts associated with a particular entity environment, such as an organizational environment, business environment, and/or the like. By way of example, a prediction domain may include a particular business domain that includes a plurality of transcripts corresponding to a business entity. In some examples, the plurality of transcripts may form at least a portion of a training dataset for training a machine learning model, such as the machine learning summarization model 314, to generate summaries that are tailored to a particular prediction domain.

In some embodiments, an initialization operation 302 is an iteration of the initialization phase 310 of a multi-phase training process 300 for the machine learning summarization model 314. An initialization operation 302 may include initializing the machine learning summarization model 314 by generating and/or updating an initial weight set 304 for the machine learning summarization model 314. The initial weight set 304, for example, may include one or more weighted parameters for one or more portions of the machine learning summarization model 314. For instance, the initial weight set 304 may include one or more weighted parameters for an encoder and/or decoder layers of the machine learning summarization model 314. An initialization operation 302 may include generating and/or updating the initial weight set 304 using one or more supervised training techniques, such as backpropagation of errors to optimize a loss metric. In some examples, the loss metric may include an aggregated initialization loss generated using a machine learning initialization model.

In some embodiments, an initial weight set 304 is a data entity that describes one or more weighted parameters for the machine learning summarization model 314. In some examples, the initial weight set 304 includes one or more weighted parameters for at least a portion of a machine learning summarization model 314. By way of example, the initial weight set 304 may include one or more weighted parameters for an encoding and/or decoding transformer of the machine learning summarization model 314.

The training phase 312 may follow the initialization phase 310 and may preload the initial weight set 304 to perform a plurality training iterations. Each iteration may include a training operation 306 during which an optimized weight set 308 for the machine learning summarization model 314 is generated and/or refined to optimize the machine learning summarization model 314 for the particular prediction domain.

In some embodiments, a training operation 306 is an iteration of a training phase 312 of the multi-phase training process 300 for the machine learning summarization model 314. A training operation 306 may include training the machine learning summarization model 314 by generating and/or updating an optimized weight set 308 for the machine learning summarization model 314. The optimized weight set 308, for example, may include one or more weighted parameters for one or more portions of the machine learning summarization model 314. For instance, the optimized weight set 308 may include one or more weighted parameters for an encoder, decoder, and/or language model portion of a machine learning summarization model 314. A training operation 306 may include generating and/or updating the optimized weight set 308 using one or more reinforcement learning training techniques, such as agent-based reinforcement learning using a reward metric. In some examples, the reward metric may include an aggregated reward metric generated using a machine learning training model.

In some embodiments, an optimized weight set 308 is a data entity that describes one or more weighted parameters for the machine learning summarization model 314. In some examples, an optimized weight set 308 includes one or more weighted parameters for at least a portion of a machine learning summarization model 314.

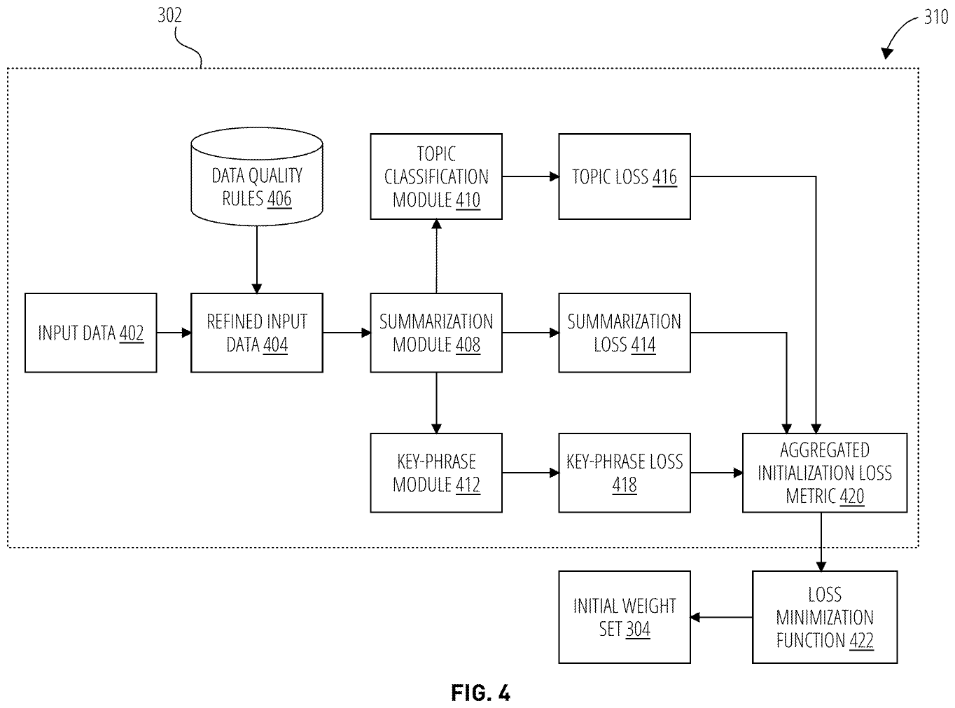

The initial weight set 304 and the optimized weight set 308 may each be generated using different training model. For example, the initial weight set 304 may be generated by a machine learning initialization model that includes multiple branches, one of which being the machine learning summarization model 314. During the initialization phase 310, the machine learning summarization model 314 may be initially trained using a supervised strategy for weight initialization using an aggregated reward metric generated by the machine learning initialization model. An example of the initialization phase 310 will now further be described with reference to FIG. 4.

FIG. 4 provides a dataflow diagram showing an example initialization phase 310 of the multi-phase training process in accordance with some embodiments discussed herein. The initialization phase 310 may include one or more steps, phases, and/or the like, for initializing one or more parameters of machine learning model. The initialization phase 310 may include a plurality of iterations of initialization operations 302. At each initialization operation 302, input data 402 may be received and leveraged to generate an aggregated initialization loss metric 420. The input data 402 may include one or more data entities from a training dataset for a particular prediction domain.

In some embodiments, the training dataset is domain data for a particular prediction domain. The training dataset may include a plurality of training transcripts and/or target summaries respectively corresponding to the training transcripts. For example, the training dataset may include a labeled training dataset with a plurality of transcript data objects. Each transcript data object may include a training transcript and a target summary (e.g., a transcript-summary pair, etc.), one or more example summaries (e.g., transcript-example pairs, etc.), and/or a target topic (e.g., transcript-summary-topic pair) for the training transcript. The one or more example summaries may include a positive and/or negative summary for a training transcript.

In some examples, the training dataset may include a key-phrase dataset. A key-phrase dataset may include a plurality of key phrases, each indicative of a historical and/or designated utterance, phrase, sentence, and/or any other keyword or sequence of one or more keywords corresponding to a prediction domain.

In some embodiments, a training transcript is a transcript included in a training dataset for a prediction domain. The training transcript may include an initialization training transcript for an initialization phase of the machine learning summarization model and/or a training transcript for a training phase of the machine learning summarization model. In some examples, the initialization training transcript and the training transcript may be the same.

In some embodiments, a target summary is a ground truth summary for a training transcript. A target summary may be descriptive of a desired summary for a corresponding transcript. A target summary may include a plurality of target summary sentences that are descriptive of one or more important aspects of a corresponding transcript. A respective target summary may be manually generated and/or automatically generated using one or more summarization techniques.

In some embodiments, a target topic classification is a ground truth topic classification for a training transcript. A topic classification, for example, may be indicative of a predictive category of a training transcript. The ground truth topic classification may be indicative of a known predictive category of the training transcript.

In some embodiments, the input data 402 for an initialization operation 302 includes an initializing transcript, an initializing target summary, a target topic, and/or a key-phrase dataset corresponding to a target prediction domain. In some examples, the training dataset and the key-phrase dataset may correspond to a target prediction domain. For example, the training dataset the initializing transcript may be one of a plurality of initializing transcripts for a target prediction domain. In some examples, the machine learning summarization model is previously trained for a nontarget prediction domain different from the target prediction domain. The initialization phase 310 may be performed to adapt the machine learning summarization model to the target prediction domain.

In some examples, the input data 402 may be preprocessed using one or more data quality rules 406 to generate refined input data 404. For example, for a training transcript derived from an audio dialog, data quality rules 406 may be leverage by a preprocessing module that uses an Aho-Corasick algorithm for searching multipattern, string matching and replacing entities in linear time. The data quality rules 406, for example, may include a rule-based dictionary for cleansing of vocabulary which are wrongly uttered due to noise in a transcript. This improve that machine learning training model by allowing the model to infer in sub-second latency along with pre-processing making the model ideal for real-time applications.

In some embodiments, the refined input data 404 is provided to a machine learning initialization model. The initial weight set 304 may be generated during the initialization phase 310 of the machine learning summarization model by including the model within the machine learning initialization model. For example, during the initialization phase 310, the machine learning summarization model may be a first branch of one or more branches in a branched initialization neural architecture of the machine learning initialization model. The machine learning summarization model, for example, may be the summarization module 408 of a machine learning initialization model that includes the summarization module 408, a topic classification module 410, and/or a key-phrase module 412.

In some embodiments, the machine learning initialization model is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning initialization model may include one or more machine learning models configured, trained (e.g., jointly, separately, etc.), and/or the like to generate one or more training outputs for generating an initial weight set 304 for the machine learning summarization model. The machine learning initialization model may include one or more of any type of machine learning model including one or more supervised, unsupervised, semi-supervised, reinforcement learning models, and/or the like. In some examples, the machine learning initialization model may include multiple models configured to perform one or more different stages of the initialization phase 310 of the multi-phase training process.

In some embodiments, the machine learning initialization model includes one or more neural networks. For example, the machine learning initialization model may include a branched neural network architecture (e.g., a branched initialization neural network architecture) that includes one or more branches, or modules. The branched neural network architecture, for example, may include a branched network architecture with three branches. The first branch may include the summarization module 408, such as the machine learning summarization model described herein. The second branch may include topic classification module 410, such as a transformer-based classification module. The third branch may include a key-phrase module 412.

The summarization module 408 may be configured to generate and/or output an initializing summary during an iteration (e.g., initialization operation 302) of the initialization phase 310 of the machine learning summarization model. The topic classification module 410 may be configured to generate and/or output a topic classification corresponding to a summary, such as the initializing summary during an iteration (e.g., initialization operation 302) of the initialization phase 310 of the machine learning summarization model. The key-phrase module may be configured to generate and/or output one or more key phrases corresponding to a summary, such as the initializing summary during an iteration (e.g., initialization operation 302) of the initialization phase 310 of the machine learning summarization model.

In some examples, the second and third branches may include pretrained neural networks with a plurality of frozen weights, respectively, during the initialization phase 310 of the machine learning summarization model. The first branch may include a modifiable weight set that may be modified to generate the initial weight set 304 for the machine learning summarization model. The initial weight set 304 may be trained using supervised learning (e.g., backpropagation of errors, etc.) with a loss minimization function configured to minimize an aggregated initialization loss derived from a weighted sum of a summarization loss 414, a topic loss 416, and/or a key-phrase loss 418.

In some embodiments, an initializing summary is generated for an initializing transcript using the first branch of the machine learning initialization model. For example, the initializing summary may be generated using the summarization module 408, which may include the machine learning summarization model. In some embodiments, the initializing summary may be provided to the second and/or third branches of the machine learning initialization model. In some embodiments, a topic classification for the initializing summary may be generated using the second branch of the one or more branches of the machine learning initialization model. The second branch, for example, may include the topic classification module 410. In some embodiments, one or more key phrases for the initializing summary may be generated using the third branch of the one or more branches of the machine learning training model. The third branch, for example, may include the key-phrase module 412.

In some embodiments, one or more of a first, second, or third initialization loss metric is generated for the machine learning summarization model using the first, second, or third branches of the machine learning initialization model. For example, a first initialization loss metric may be based on a comparison between the initializing summary and an initializing target summary corresponding to the initializing transcript (e.g., from the input data 402). The first initialization loss metric, for example, may include a summarization loss 414. The second initialization loss metric may be based on a comparison between the topic classification and a target topic classification corresponding to the initializing transcript (e.g., from the input data 402). The second initialization loss metric, for example, may include a topic loss 416. The third initialization loss metric may be based on a comparison between the one or more key phrases and the key-phrase dataset corresponding to a target prediction domain. The third initialization loss metric, for example, may include a key-phrase loss 418.

In some embodiments, the summarization loss 414 is a data entity that describes a first initialization loss metric for a machine learning model, such as the machine learning summarization model. The summarization loss 414 may be based on a comparison between (i) an initializing summary generated by a first branch (e.g., at least a portion of a machine learning summarization model) of the machine learning initialization model for an initializing transcript and (ii) an initializing target summary for the initializing transcript. An initializing transcript and/or initializing target summary may correspond to a transcript data object of a training dataset.

In some embodiments, a summarization loss 414 includes a supervised loss metric for a machine learning summarization model. A summarization loss 414, for example, may include a mean square error, quadratic, and/or L2 loss. In addition, or alternatively, a summarization loss 414 may include a mean absolute error and/or L1 loss. In some examples, a summarization loss 414 may include a log-cosh loss and/or quantile loss.

In some embodiments, the topic loss 416 is a data entity that describes a second initialization loss metric for a machine learning model, such as the machine learning summarization model. A topic loss 416 may be based on a comparison between (i) a first topic classification generated by a second branch (e.g., the topic classification module 410) of the machine learning initialization model for an initializing summary and (ii) a second topic classification for an initializing target summary corresponding to the initializing transcript. In some embodiments, the topic loss 416 may be indicative of a supervised loss metric for the machine learning summarization model, such as a classification loss function including binary cross-entropy loss, log loss, hinge loss, and/or the like.

In some embodiments, the key-phrase loss 418 is a data entity that describes a third initialization loss metric for a machine learning model, such as a machine learning summarization model. The key-phrase loss 418 may be based on a comparison between one or more key phrases extracted from an initializing summary by a third branch (e.g., the key-phrase module 412) of the machine learning initialization model and a key-phrase dataset. In some embodiments, the key-phrase loss 418 may be indicative of a supervised loss metric for the machine learning summarization model, such as a named entity recognition loss, and/or the like

In some embodiments, an aggregated initialization loss metric 420 is generated using one or more of the first, second, and third initialization loss metrics. For example, the aggregated initialization loss metric 420 may include a weighted sum of one or more of the first initialization loss metric, the second initialization loss metric, and/or the third initialization loss metric. In some examples, the aggregated initialization loss metric 420 may include a weighted sum of the first initialization loss metric, the second initialization loss metric, and/or the third initialization loss metric.

In some embodiments, the aggregated initialization loss metric 420 is a data entity that describes a total loss metric for a machine learning model, such as the machine learning summarization model. An aggregated initialization loss may include a weighted sum of the summarization loss 414, topic loss 416, and/or key-phrase loss 418.

In some embodiments, the initial weight set 304 is generated and/or refined using a loss minimization function based on the aggregated initialization loss metric 420. The loss minimization function 422, for example, may include one or more supervisory training techniques, such as back propagation of errors, to modifying the initial weight set 304 to minimize the aggregated initialization loss metric 420.

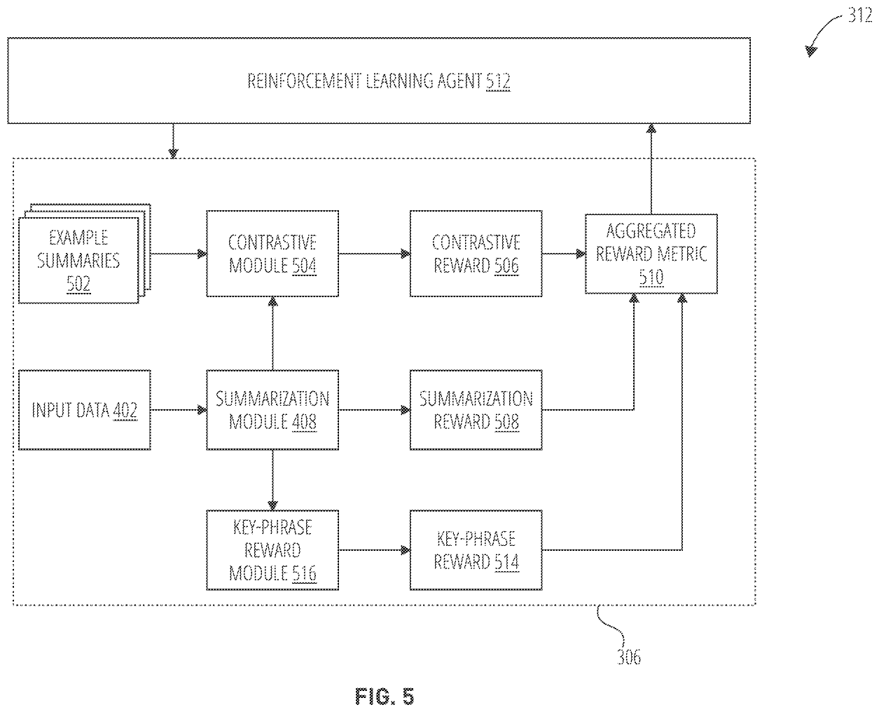

As described herein, the initial weight set 304 may be leveraged in a subsequent training phase 312 to generate an optimized weight set for the machine learning summarization model. For example, the initial weight set 304 may be leveraged by a machine learning training model that includes multiple branches, one of which being the machine learning summarization model that is preloaded with initial weight set. During a training phase, the machine learning summarization model may be optimized using a reinforcement learning strategy for weight optimization using an aggregated reward metric generated by the machine learning training model. An example of the training phase will now further be described with reference to FIG. 5.

FIG. 5 provides a dataflow diagram showing an example training phase 312 of the multi-phase training process in accordance with some embodiments discussed herein. The training phase 312 may include one or more steps, phases, and/or the like, for optimizing one or more parameters of a machine learning model, such as the machine learning summarization model. The training phase 312 may include a plurality of iterations of training operation 306.

At each training operation 306, input data 402 may be received and leveraged to generate an aggregated reward metric 510. The input data 402 may include one or more data entities from a training dataset for a particular prediction domain. In some embodiments, the input data 402 may include data from the same training dataset used to generate the initial weight set. The input data 402, for example, may include a training transcript and a target summary corresponding to the training transcript.

In some embodiments, the input data 402 is provided to a machine learning training model. The optimized weight set may be generated during the training phase 312 of the machine learning summarization model by including the model within the machine learning training model. For example, during the training phase 312, the machine learning summarization model may be a first branch in a branched training neural architecture of the machine learning training model that includes a first branch, a second branch, and a third branch. The machine learning summarization model, for example, may be the summarization module 408 of the machine learning training model that includes the summarization module 408, a contrastive module 504, and/or the key-phrase reward module 516. In some examples, the first branch (e.g., summarization module 408) may include one or more modifiable parameters, whereas the second branch (e.g., contrastive module 504) and/or the third branch (e.g., key-phrase reward module 516) may include one or more pretrained machine learning models with frozen parameters.

In some embodiments, the machine learning training model is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning training model may include one or more machine learning models configured, trained (e.g., jointly, separately, etc.), and/or the like to generate one or more training outputs for generating an optimized weight set for the machine learning summarization model. The machine learning training model may include one or more of any type of machine learning model including one or more supervised, unsupervised, semi-supervised, reinforcement learning models, and/or the like. In some examples, the machine learning training model may include multiple models configured to perform one or more different stages of a training process.

In some embodiments, the machine learning training model includes one or more neural networks. For example, the machine learning training model may include a branched neural network architecture (e.g., a branched training neural network architecture) that includes one or more branches, or modules. The branched neural network architecture, for example, may include a branched network architecture with three branches. A first branch may include the summarization module 408, such as the machine learning summarization model preloaded with an initial weight set as described herein. A second branch may include a contrastive module 504 and a third branch may include a key-phrase reward module 516.

The summarization module 408 may be configured to generate and/or output a training summary during an iteration (e.g., training operation 306) of a training phase 312 of the machine learning summarization model. The contrastive module 504 may be configured to generate and/or output a contrastive reward 506 corresponding to the training summary. The key-phrase reward module 516 may be configured to generate and/or output a key-phrase reward 514 corresponding to the training summary.

In some examples, the second and third branches may include pretrained neural networks with a plurality of frozen weights, respectively, during the training phase 312 of the machine learning summarization model. The first branch may include a modifiable weight set that may be modified to generate an optimized weight set for the machine learning summarization model. For example, the machine learning summarization model may be preloaded with fine-tuned weights (e.g., initial weight set) generated during an initialization phase of a multi-phase training process. The optimized weight set may be trained using reinforcement learning using a reinforcement learning agent 512 configured to optimize an aggregate reward function derived from a weighted sum of a summarization reward 508, a contrastive reward 506, and/or a key-phrase reward 514.

In some embodiments, a training summary for a training transcript is generated using the summarization module 408. For example, the summarization module 408 may include the machine learning summarization model. In some examples, the summarization module 408 may include the machine learning summarization model preloaded with an initial weight set. For example, the initial weight set may be previously generated, using one or more supervised loss functions as described herein with reference to the initialization phase. In some embodiments, the training summary may be based on the initial weight set. In some embodiments, the training summary may be provided to the second and/or third branches of the machine learning training model.

In some embodiments, one or more probability distributions may be generated for the training summary and/or one or more example summaries 502 using the second branch of the machine learning training model. The second branch, for example, may include a contrastive module 504.

In some embodiments, one or more training key phrases may be generated for the training summary and/or a target summary corresponding to the training transcript using the third branch of the machine learning training model. The third branch, for example, may include the key-phrase reward module 516, which may include the key-phrase module 412 from the initialization phase. The one or more training key phrases, for example, may include one or more first key phrases for the training summary and/or one or more second key phrases for the target summary that are generated by the third branch of the branched training neural architecture.

In some embodiments, one or more of a first, second, or third reward metric is generated for the machine learning summarization model using the first, second, or third branches of the machine learning training model. For example, a first reward metric for the machine learning summarization model may be generated based on a comparison between the training summary and a target summary corresponding to the training transcripts. The first reward metric, for example, may include a summarization reward 508. The second reward metric may be generated based on the training summary and/or one or more example summaries 502, such as a positive summary and/or a negative summary corresponding to the training transcript. The second reward metric, for example, may include a contrastive reward 506. The third reward metric may be generated based on one or more training key phrases from the training summary. The third reward metric, for example, may be based on a comparison between the one or more training key phrases and/or one or more target key phrases generated by the third branch of the branched training neural architecture for the target summary. The third reward metric, for example, may include a key-phrase reward 514.

In some embodiments, the summarization reward 508 is a data entity that describes a first reward metric for a machine learning model, such as a machine learning summarization model. A summarization reward 508 may be based on a comparison between a training summary and a target summary corresponding to the training summary. A training summary, for example, may be generated by a first branch (e.g., at least a portion of a machine learning summarization model) of the machine learning training model for a training transcript. A target summary may be from a transcript data object of a training dataset that corresponds to the training transcript.

In some embodiments, the summarization reward 508 is generated based on one or more discrete probability distributions. For example, a summarization reward may be based on a distance (e.g., inverse Fisher-Rao Distance, etc.) between a first probability distribution for a training summary and a second probability distribution for a target summary. Each probability distribution, for example, may include an inverse document frequency distribution, such as a discrete probability distribution over masked tokens for masked summaries generated from a training and target summary, respectively.

In some embodiments, the summarization reward 508 is generated by generating a masked training summary for the training summary and a masked target summary for the target summary. The masked summaries, for example, may be generated by using a machine learning masked language model, such as the machine learning masked language model described herein with reference to the contrastive module 504. In some embodiments, the masked target summary may be generated using the same machine learning masked language model as the contrastive module 504.

A first discrete probability distribution may be generated for the masked training summary using an inverse document frequency distribution. In addition, or alternatively, a second discrete probability distribution may be generated for the masked target summary using the inverse document frequency distribution. In some examples, the summarization reward 508 (e.g., a first reward metric) may be generated based on a distance between the first discrete probability distribution and the second discrete probability distribution. In some examples, the distance may be a Fisher-Rao distance.

In some embodiments, the contrastive reward 506 is a data entity that describes a second reward metric for a machine learning model, such as the machine learning summarization model. The contrastive reward 506 may be based on a training summary, a positive summary, and/or a negative summary. In some examples, the contrastive reward 506 may be generated using the contrastive module 504 based on a weighted aggregation of a sentence-level reward and a masked language model reward as described herein.

In some embodiments, the key-phrase reward 514 is a data entity that describes a third reward metric for a machine learning model, such as a machine learning summarization model.

The key-phrase reward 415 may be based on one or more training key phrases from a training summary. A key-phrase reward 514 may be based on a comparison between one or more key phrases extracted from a training and target summary, respectively. For example, the key-phrase reward 514 may include a distance, such as a word mover's distance, a cosine distance, and/or the like, that is indicative of a similarity between the key phrases extracted for the training and target summaries.

In some embodiments, the aggregated reward metric 510 is generated based on one or more of the first, second, and/or third reward metrics. For example, the aggregated reward metric 510 may include a weighted sum of one or more of the first reward metric, the second reward metric, and/or the third reward metric. In some examples, the aggregated reward metric 510 may include a weighted sum of the first reward metric, the second reward metric, and/or the third reward metric.

In some embodiments, the aggregated reward metric 510 is a data entity that describes a total reward metric for a machine learning model, such as a machine learning summarization model. The aggregated reward metric may include a weighted sum of the summarization reward 508, contrastive reward 506, and/or key-phrase reward 514.

In some embodiments, the performance of one or more training operations for the machine learning summarization model may be initiated based on the aggregated reward metric 510. The one or more training operations, for example, may include modifying a weight set of the machine learning summarization model to generate the optimized weight set 308. The weight set, for example, may be modified by the reinforcement learning agent 512 based on the aggregated reward metric 510.

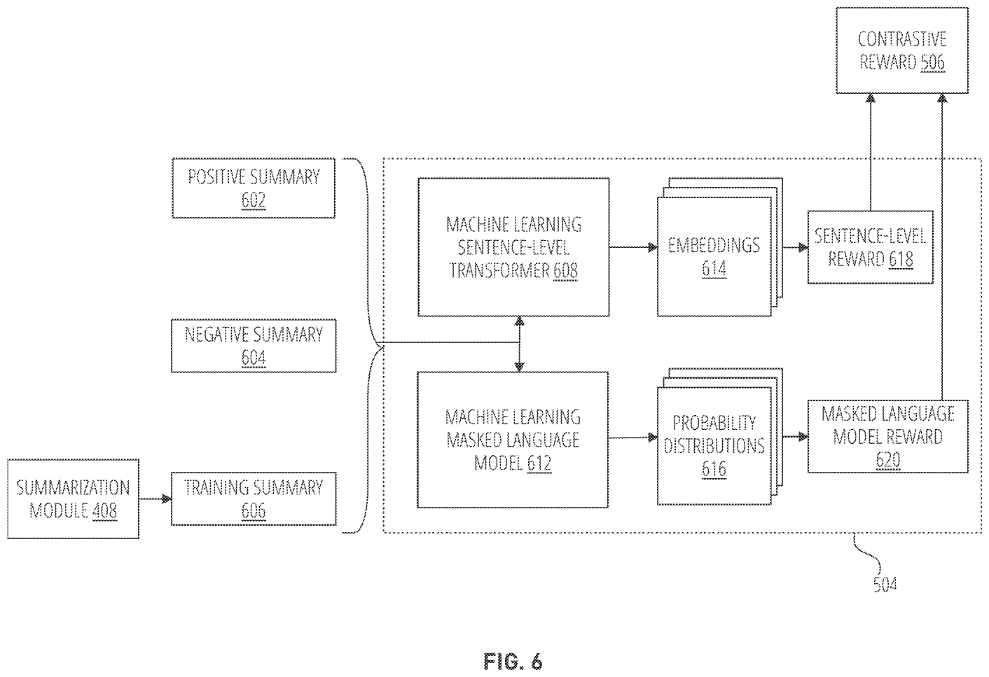

As described herein, the aggregated reward metric 510 may include a weighted combination of rewards, individually generated using one or more different approaches directly tailored to overcome deficiencies with traditional training techniques. As one example, the contrastive reward may be configured to mitigate the issue of hallucinations/out of context information. Which were one of the biggest drawbacks of contemporary models. An example of the operations for generating the contrastive reward will now further be described with reference to FIG. 6.

FIG. 6 provides a dataflow diagram showing an example operation of a contrastive module 504 in accordance with some embodiments discussed herein. The contrastive module 504 (e.g., a second branch of the machine learning training model, etc.) may include one or more machine learning models collectively configured to generate a contrastive reward 506 based on one or more inputs. For example, the contrastive module 504 (e.g., the second branch) may include a machine learning sentence-level transformer 608 and/or a machine learning masked language model 612 that are each configured to generate intermediate representations of the one or more inputs. The one or more inputs may include a training summary 606 output by the summarization module 408 and/or one or more example summaries. The example summaries may include a positive summary 602 and/or a negative summary 604. The contrastive module 504 may be configured to generate the contrastive reward 506 based on one or more comparisons between the positive summary 602, the negative summary 604, the training summary 606, and/or intermediate representations thereof.

In some embodiments, a positive summary 602 is a positive training sample for a training summary. In some examples, the positive training sample may include a paraphrased target summary for a training transcript. The positive summary 602 may be leveraged to generate a reward for a machine learning summarization model based on a comparison between the positive summary 602 and a summary output by the machine learning summarization model. In some embodiments, a negative summary 604 is a negative training sample for a training summary. In some examples, the negative training sample may include a paraphrased target summary for a training transcript that is augmented to remove and/or change one or more key words, phrases, and/or the like to degrade the quality of the paraphrased target summary. A negative summary 604 may be leveraged to generate a penalty for a machine learning summarization model based on a comparison between the negative summary 604 and a summary output by the machine learning summarization model.

In some embodiments, the contrastive module 504 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The contrastive module 504 may include one or more machine learning models configured, trained (e.g., jointly, separately, etc.), and/or the like to generate contrastive reward 506 for a machine learning summarization model. The contrastive module 504 may include one or more of any type of machine learning model including one or more supervised, unsupervised, semi-supervised, reinforcement learning models, and/or the like. In some examples, the contrastive module 504 may include multiple models configured to perform one or more different stages of an evaluation process. The one or more models, for example, may include a machine learning sentence-level transformer 608 and/or a machine learning masked language model 612.

In some embodiments, one or more embeddings 614 are generated, using the machine learning sentence-level transformer 608, for the positive summary 602, the negative summary 604, and/or training summary 606. The embeddings 614, for example, may include a training embedding for the training summary 606, a positive embedding for the positive summary 602, and/or a negative embedding for the negative summary 604.

In some embodiments, the machine learning sentence-level transformer 608 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning sentence-level transformer 608 may include a transformer model, such as a BERT model that may be previously finetuned for a prediction domain using a training dataset. The machine learning sentence-level transformer 608 may be configured to generate a plurality of embeddings 614 for one or more input summaries, such as the training summary 606, the negative summary 604, and/or the positive summary 602.

In some embodiments, an embedding 614 is to data entity that describes an embedding for an input summary. An embedding 614, for example, may include a text embedding including a real-valued vector that encodes one or more attributes for an input summary. An embedding 614 may include a training embedding generated for the training summary 606, a positive embedding generated for the positive summary 602, and/or a negative embedding generated for a negative summary 604.

In some embodiments, a sentence-level reward 618 is generated based on a first comparison between the positive embedding, the negative embedding, and the training embedding. The first comparison, for example, may include a first cosine similarity between the positive embedding and the training embedding divided by a second cosine similarity between the negative embedding and the training embedding.

In some embodiments, a sentence-level reward 618 is a data entity that describes a portion of a second reward metric for a machine learning model, such as a machine learning summarization model. A sentence-level reward 618, for example, may include a portion of a contrastive reward 506. A sentence-level reward 618 may be based on a plurality of embeddings 614 generated by the machine learning sentence-level transformer 608. For example, a plurality of embeddings 614 may include a training embedding, a positive embedding, and/or a negative embedding. In some examples, the sentence-level reward 618 may include a distance between each of the training, positive, and/or a negative embeddings. By way of example, the sentence-level reward 618 may include a cosine similarity distance between the plurality of embeddings. In this manner, the sentence-level reward 618 may ensure that global level features and/or lexical similarities are captured which can mitigate sentence level hallucination problems, such as grammatical mistakes, structural issues, out of context sentences, and/or the like.

In some embodiments, one or more probability distributions 616 are generated, using the machine learning masked language model 612, for the positive summary 602, the negative summary 604, and/or the training summary 606. The probability distributions 616 may be based on masked summaries generated by a first portion of the machine learning masked language model 612. Each masked summary may include a tokenized version of a respective summary to mitigate the issue of hallucinations and/or out of context information within the summary. The probability distributions 616 may include distributions for each of the masked summaries. For example, using a second portion of the machine learning masked language model 612 (e.g., an inverse document frequency function, etc.), a training probability distribution may be generated for a masked training summary for the training summary 606, a positive probability distribution may be generated for a masked positive summary for the positive summary 602, and a negative probability distribution may be generated for a negative masked training summary for the negative summary 604.

In some embodiments, the machine learning masked language model 612 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The machine learning masked language model 612, for example, may include BERT-based masked language model that may be previously finetuned for a prediction domain using a training dataset. The machine learning masked language model 612 may be configured to generate a plurality of masked summaries for one or more input summaries and output discrete probability distributions 616 of masked tokens for each of the masked summaries.

In some embodiments, a masked language model reward 620 may be generated based on a second comparison between the masked training summary, the masked positive summary, and/or the masked negative summary. The second comparison, for example, may include a first distance between the masked positive summary and the masked training summary divided by a second distance between the masked negative summary and the masked training summary.

In some embodiments, the masked language model reward 620 is a data entity that describes a portion of a second reward metric for a machine learning model, such as a machine learning summarization model. The masked language model reward 620, for example, may include a portion of the contrastive reward 506. A masked language model reward 620 may be based on a plurality of probability distributions 616 generated by the machine learning masked language model 612. The plurality of probability distributions 616, for example, may include a training distribution generated for the training summary 606, a positive distribution generated for the positive summary 602, and/or a negative distribution generated for the negative summary 604. Each discrete probability distribution may include a distribution of masked tokens passed through an inverse document frequency such that one or more key words of the distribution receive a higher weightage than the common words like stop-words or irrelevant words. The masked language model reward 620 may include a distance (e.g., a Fisher-Rao Distance, etc.) between the training distribution, the positive distribution, and/or the negative distribution. The masked language model reward 620 may enable a non-parametric way to replace word/token level hallucination in the form of garbage words, out of context words, word spelling errors, singular/plural features, and/or the like.

In some embodiments, the second reward metric (e.g., the contrastive reward 506) may be generated based on the sentence-level reward 618 and/or the masked language model reward 620. By way of example, the second reward metric may include a weighted sum between the first comparison (e.g., sentence-level reward) and/or the second comparison (e.g., masked language model reward 620).

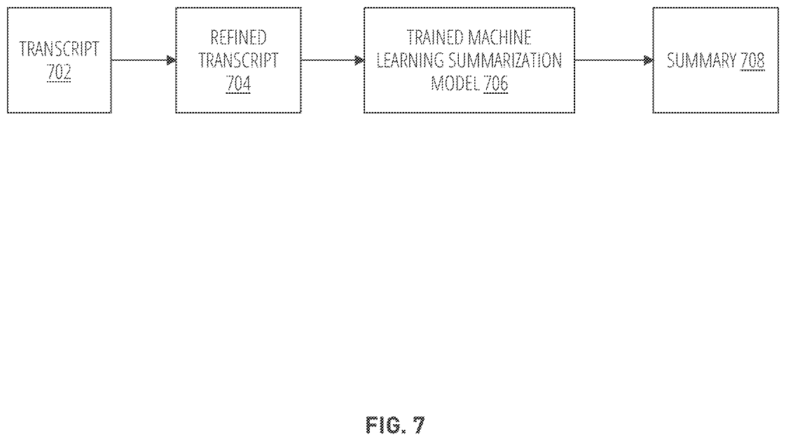

FIG. 7 provides a dataflow diagram showing an example operation 700 of a trained machine learning summarization model in accordance with some embodiments discussed herein. The trained machine learning summarization model 706 may include an optimized weight set generated in accordance with one or more of the techniques described herein. After the multi-phase training process, the trained machine learning summarization model 706 may be removed from the machine learning initialization model and/or machine learning training model and used, individually, to generate a summary 708 for a transcript 702. In some examples, the transcript 702 may be preprocessed, using the one or more data quality rules described herein, to generate a refined transcript 704 before generating the summary 708.

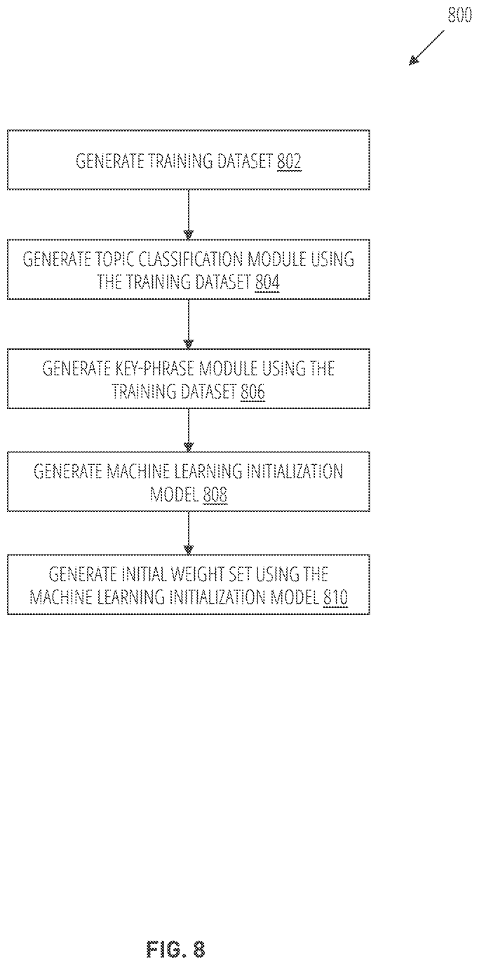

FIG. 8 is a flowchart showing an example of a process 800 for initializing a machine learning summarization model in accordance with some embodiments discussed herein. The flowchart depicts a first phase of a multi-phase training process for generating a machine learning summarization model to overcome various limitations of traditional model training techniques. The first phase may be implemented by one or more computing devices, entities, and/or systems described herein. For example, via the various steps/operations of the process 800, the computing system 100 may generate and leverage a machine learning initialization model to overcome the various limitations with traditional training techniques by adapting a model to a prediction domain before a second phase of the multi-phase training process.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 includes, at step/operation 802, generating a training dataset. For example, the computing system 100 may generate the training datasets for a particular prediction domain. In some examples, the computing system 100 may leverage one or more automatic speech recognition techniques to generate a plurality of training transcripts. In addition, or alternatively, the training transcripts may be received from one or more data sources, such as one or more transcript databanks, and/or the like. The computing system 100 may generate one or more training summaries for the plurality of training transcripts using one or more automatic summary generation techniques and/or manual input. In some examples, a rule based filter may be applied for entity boosting. The computing system 100 may generate target topic classifications and a key-phrase dataset based on the one or more training summaries. The target topic classification and/or key-phrase dataset may be generated automatically and/or through manual input.

In some embodiments, the process 800 includes, at step/operation 804, generating a topic classification module using the training dataset. For example, the computing system 100 may generate the topic classification module. The topic classification module, for example, may include BERT-based topic classification model. The computing system 100 may generate the topic classification module by fine-tuning the BERT-based topic classification model using a plurality of summary-topic pairs from the training dataset.

In some embodiments, the process 800 includes, at step/operation 806, generating a key-phrase module using the training dataset. For example, the computing system 100 may generate the key-phrase module. The key-phrase module, for example, may include BERT-based key-phrase extraction model. The computing system 100 may generate the key-phrase module by fine-tuning the BERT-based key-phrase extraction model using a plurality of summary-key-phrase pairs from the training dataset.

In some embodiments, the process 800 includes, at step/operation 808, generating a machine learning initialization model. For example, the computing system 100 may generate the machine learning initialization model based on the trained topic classification module and/or key-phrase module. For example, the computing system 100 may integrate the pretrained topic classification module and the key-phrase module with a machine learning summarization model to create a branch neural network architecture.

In some embodiments, the process 800 includes, at step/operation 810, generating an initial weight set using the machine learning initialization model. For example, the computing system 100 may generate the initial weight set using the machine learning initialization model by modifying weights of a machine learning summarization model through a plurality of iterations of initialization operations. In this manner, an initial weight set may be generated during an initialization phase of the machine learning summarization model and, during the initialization phase, the machine learning summarization model may include a first branch of one or more branches in a branched initialization neural architecture.

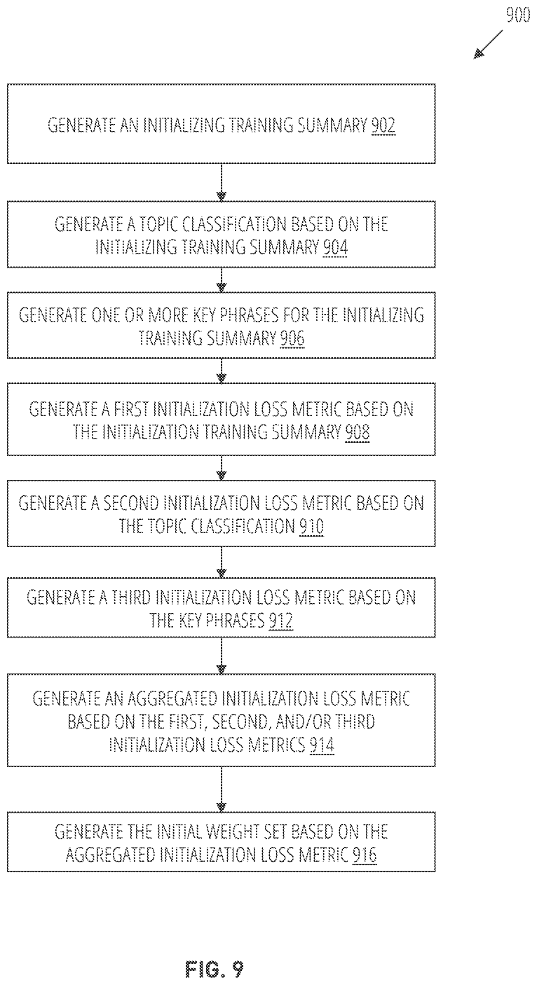

FIG. 9 is a flowchart showing an example of a process 900 for generating an initial weight set for a machine learning model in accordance with some embodiments discussed herein. The flowchart depicts the first phase of the multi-phase training process for generating the machine learning summarization model to overcome various limitations of traditional model training techniques. The process 900 includes initialization techniques for generating the initial weight set at step/operation 810 of the process 800. The initialization techniques may be implemented by one or more computing devices, entities, and/or systems described herein. For example, via the various steps/operations of the process 900, the computing system 100 may leverage a machine learning initialization model to generate an initial weight set for a machine learning model to adapt to model to a particular prediction domain. By doing so, the initialization techniques implemented by the process 900 may overcome the various limitations with traditional training techniques by tailoring initial model weights to a particular prediction domain.

FIG. 9 illustrates an example process 900 for explanatory purposes. Although the example process 900 depicts a particular sequence of steps/operations, the sequence may be altered without departing from the scope of the present disclosure. For example, some of the steps/operations depicted may be performed in parallel or in a different sequence that does not materially impact the function of the process 900. In other examples, different components of an example device or system that implements the process 900 may perform functions at substantially the same time or in a specific sequence.

In some embodiments, the process 900 includes, at step/operation 902, generating an initializing summary. For example, the computing system 100 may generate, using the first branch of the machine learning initialization model, the initializing summary for an initializing transcript. In some examples, the initializing transcript may be one of a plurality of initializing transcripts for a training dataset that corresponds to the target prediction domain. In some examples, the machine learning model may be previously trained for a nontarget prediction domain different from the target prediction domain.

In some embodiments, the process 900 includes, at step/operation 904, generating an initializing topic classification based on the initializing summary. For example, the computing system 100 may generate, using a second branch of the one or more branches of the machine learning initialization model, a topic classification for the initializing summary.

In some embodiments, the process 900 includes, at step/operation 906, generating one or more key phrases for the initializing summary. For example, the computing system 100 may generate, using a third branch of the one or more branches of the machine learning initialization model, one or more key phrases for the initializing summary.

In some embodiments, the process 900 includes, at step/operation 908, generating a first initialization loss metric based on the initializing summary. For example, the computing system 100 may generate the first initialization loss metric based on a comparison between the initializing summary and an initializing target summary corresponding to the initializing transcript. The first initialization loss metric may include the summarization loss.

In some embodiments, the process 900 includes, at step/operation 910, generating a second initialization loss metric based on the topic classification. For example, the computing system 100 may generate a second initialization loss metric based on a comparison between the topic classification and a target topic classification corresponding to the initializing transcript. The second initialization loss metric may include the topic loss.

In some embodiments, the process 900 includes, at step/operation 912, generating a third initialization loss metric based on the key phrases. For example, the computing system 100 may generate the third initialization loss metric based on a comparison between the one or more key phrases and a key phrase dataset corresponding to the target prediction domain. The third initialization loss metric may include the key-phrase loss.

In some embodiments, the process 900 includes, at step/operation 914, generating an aggregated initialization loss metric based on the first, second, and/or third initialization loss metrics. For example, the computing system 100 may generate the aggregated initialization loss metric based on a weighted sum of the first, second, and/or third initialization loss metrics.

In some embodiments, the process 900 includes, at step/operation 916, generating the initial weight set based on the aggregated initialization loss metric. For example, the computing system 100 may generate, using a loss minimization function, the initial weight set based on an aggregated initialization loss metric that includes a weighted sum of one or more of the first initialization loss metric, the second initialization loss metric, and/or the third initialization loss metric.

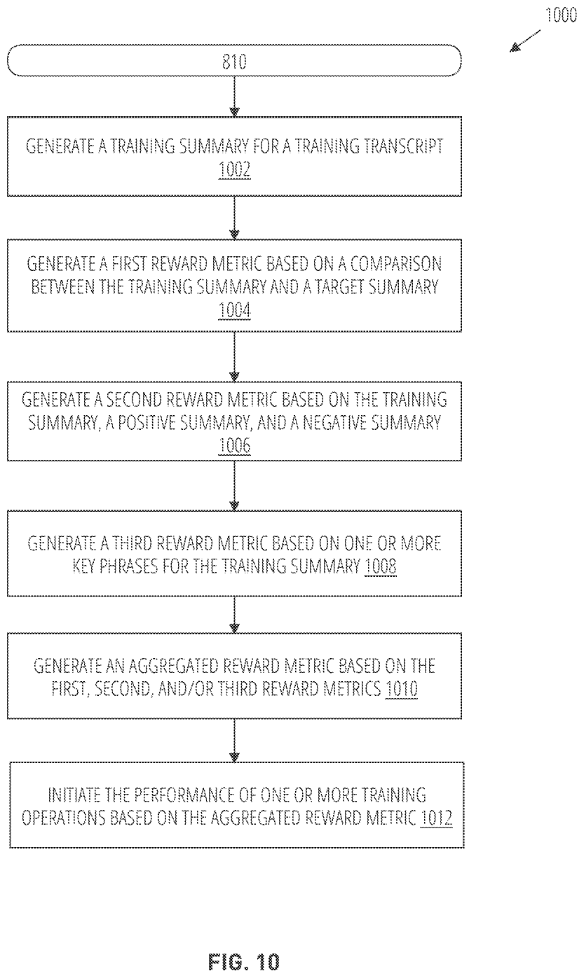

FIG. 10 is a flowchart showing an example of a process 1000 for generating an optimized weight set for a machine learning model in accordance with some embodiments discussed herein. The flowchart depicts a second phase of a multi-phase training process for generating a machine learning summarization model to overcome various limitations of traditional model training techniques. The second phase may be implemented by one or more computing devices, entities, and/or systems described herein. For example, via the various steps/operations of the process 1000, the computing system 100 may generate and leverage a machine learning training model to overcome the various limitations with traditional training techniques by generating a holistic reward metric and reinforcement learning techniques to optimize the machine learning summarization model with respect to the holistic reward metric.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence.

In some embodiments, the process 1000 may begin subsequent to step/operation 810 of process 800, where the process 800 includes generating an initial weight set weight set for the machine learning summarization model. For example, using the initialization techniques, using a supervised loss function, the initial weight set for the machine learning summarization model. The computing system 100 may leverage the initial weight set to generate training summaries during one or more steps/operations of the process 1000.

In some embodiments, the process 1000 includes, at step/operation 1002, generating a training summary for a training transcript. For example, the computing system 100 may generate, using a machine learning model, a training summary for a training transcript. In some examples, the computing system 100 may generate the training summary based on the initial weight set previously generated during an initialization phase of the machine learning summarization model. For example, the machine learning summarization model may be a first branch in a branched training neural architecture that includes the first branch, a second branch, and a third branch. In some examples, the second branch and the third branch may respectively include one or more pretrained machine learning models. The first branch may be preloaded with the initial weight set, which may be modified to generate an optimized weight set for the machine learning summarization model.

In some embodiments, the process 1000 includes, at step/operation 1004, generating a first reward metric based on a comparison between the training summary and a target summary. For example, the computing system 100 may generate the first reward metric for the machine learning summarization model based on a comparison between the training summary and a target summary corresponding to the training transcript.

In some examples, the computing system 100 may generate a masked training summary for the training summary and a masked target summary for the target summary. The computing system 100 may generate a first discrete probability distribution for the masked training summary and/or a second discrete probability distribution for the masked target summary. In some examples, the computing system may generate the first reward metric based on a distance between the first discrete probability distribution and the second discrete probability distribution. The distance, for example, may be a Fisher-Rao distance.

In some embodiments, the process 1000 includes, at step/operation 1006, generating a second reward metric based on the training summary, a positive summary, and/or a negative summary. For example, the computing system 100 may generate the second reward metric for the machine learning model based on the training summary, the positive summary, and the negative summary.

In some embodiments, the process 1000 includes, at step/operation 1008, generating a third reward metric based on one or more key phrases for the training summary. For example, the computing system 100 may generate the third reward metric for the machine learning model based on one or more training key phrases from the training summary. In some examples, the computing system 100 generates the one or more training key phrases using the third branch of the branched training neural architecture. The third reward metric may be based on a comparison between the one or more training key phrases and/or one or more target key phrases generated by the third branch of the branched training neural architecture for the target summary.

In some embodiments, the process 1000 includes, at step/operation 1010, generating an aggregated reward metric based on the first, second, and/or third reward metrics. For example, the computing system 100 may generate the aggregated reward metric based on one or more of the first reward metric, the second reward metric, and/or the third reward metric.

In some embodiments, the process 1000 includes, at step/operation 1012, initiating the performance of one or more training operations based on the aggregated reward metric. For example, the computing system 100 may initiate the performance of one or more training operations for the machine learning model based on the aggregated reward metric. For instance, the computing system 100 may modify, using a reinforcement learning agent, a weight set of the machine learning model to generate an optimized weight set based on the aggregated reward metric.

Some techniques of the present disclosure enable the generation of action outputs that may be performed to initiate one or more predictive actions to achieve real-world effects. The multi-phase training techniques of the present disclosure may be used, applied, and/or otherwise leveraged to generate a machine learning summarization model, which may help in the computer interpretation and summarization of text. The machine learning summarization model of the present disclosure may be leveraged to initiate the performance of various computing tasks that improve the performance of a computing system (e.g., a computer itself, etc.) with respect to various predictive actions performed by the computing system 100, such as for the summarization of long dialogs, chat comprehension, and/or the like. Example predictive actions may include the generation of an abstractive summary to summarize a call transcript and prediction action to automatically address aspects discussed during the call. For instance, the abstractive summary may be interpreted to determine a predictive action for addressing a concern and automatically initiating the action output.

In some examples, the computing tasks may include predictive actions that may be based on a prediction domain. A prediction domain may include any environment in which computing systems may be applied to achieve real-word insights, such as predictions (e.g., abstractive summaries, predictive intents, etc.), and initiate the performance of computing tasks, such as predictive actions e.g., updating user preferences, providing account information, cancelling an account, adding an account, etc.) to act on the real-world insights. These predictive actions may cause real-world changes, for example, by controlling a hardware component, providing alerts, interactive actions, and/or the like.

Examples of prediction domains may include financial systems, clinical systems, autonomous systems, robotic systems, and/or the like. Predictive actions in such domains may include the initiation of automated instructions across and between devices, automated notifications, automated scheduling operations, automated precautionary actions, automated security actions, automated data processing actions, automated data compliance actions, automated data access enforcement actions, automated adjustments to computing and/or human data access management, and/or the like.

In some embodiments, the multi-phase training techniques of process 1000 are applied to initiate the performance of one or more predictive actions. A predictive action may depend on the prediction domain. In some examples, the computing system 100 may leverage the multi-stage training techniques to generate a machine learning model that may be leveraged to initiate the summarization and computer comprehension of transcripts, and/or any other operations for handling complex text corpora.

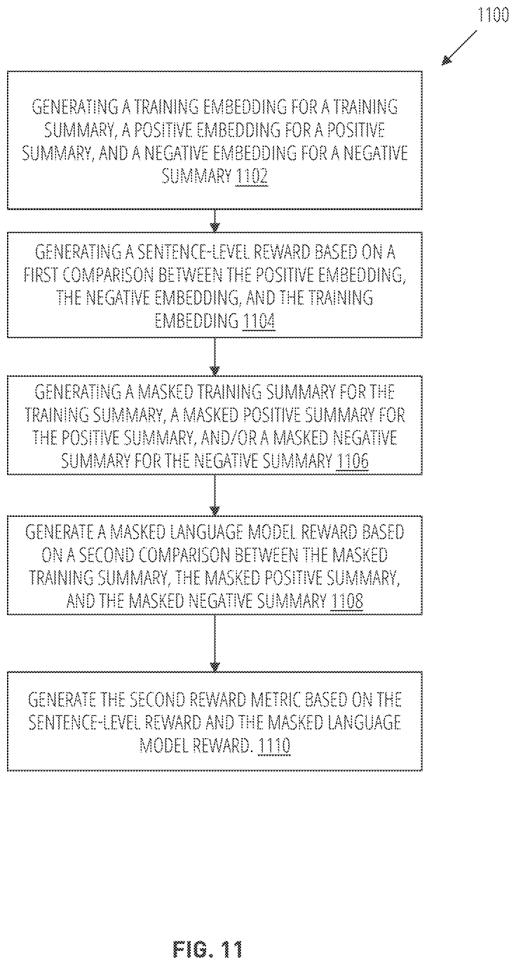

FIG. 11 is a flowchart showing an example of a process 1100 for generating a contrastive reward in accordance with some embodiments discussed herein. The flowchart depicts a portion of a second phase of a multi-phase training process for generating a machine learning summarization model to overcome various limitations of traditional model training techniques. The portion of the second phase includes contrastive reward generation techniques, as shown by step/operation 1006 of process 1000, that are directly tailored to mitigate hallucinations in abstractive summarization techniques. The contrastive reward generation techniques may be implemented by one or more computing devices, entities, and/or systems described herein. For example, via the various steps/operations of the process 1100, the computing system 100 may generate a contrastive reward for a machine learning summarization model to encourage summaries with minimal hallucinations to mitigate various limitations with traditional abstractive summarization process that include hallucinations problems, such as grammatical mistakes, structural issues, out of context sentences, and/or the like.

FIG. 11 illustrates an example process 1100 for explanatory purposes. Although the example process 1100 depicts a particular sequence of steps/operations, the sequence may be altered without departing from the scope of the present disclosure. For example, some of the steps/operations depicted may be performed in parallel or in a different sequence that does not materially impact the function of the process 1100. In other examples, different components of an example device or system that implements the process 1100 may perform functions at substantially the same time or in a specific sequence.

In some embodiments, the process 1100 includes, at step/operation 1102, generating a training embedding for a training summary, a positive embedding for a positive summary, and/or a negative embedding for a negative summary. For example, one or more steps/operations of the process 1100 may be performed using the second branch of the machine learning training model. The second branch may include a machine learning sentence-level transformer and/or a machine learning masked language model. The computing system 100 may generate, using the machine learning sentence-level transformer, the training embedding for the training summary, the positive embedding for the positive summary, and/or the negative embedding for the negative summary.

In some embodiments, the process 1100 includes, at step/operation 1104, generating a sentence-level reward based on a first comparison between the positive embedding, the negative embedding, and/or the training embedding. For example, the computing system 100 may generate a sentence-level reward based on the first comparison between the positive embedding, the negative embedding, and the training embedding. The first comparison, for example, may include a first cosine similarity between the positive embedding and the training embedding divided by a second cosine similarity between the negative embedding and the training embedding.

In some embodiments, the process 1100 includes, at step/operation 1106, generating a masked training summary for the training summary, a masked positive summary for the positive summary, and/or a masked negative summary for the negative summary. For example, the computing system 100 may generate, using the machine learning masked language model, the masked training summary for the training summary, the masked positive summary for the positive summary, and/or the masked negative summary for the negative summary.

In some embodiments, the process 1100 includes, at step/operation 1108, generating a masked language model reward based on a second comparison between the masked training summary, the masked positive summary, and/or the masked negative summary. For example, the computing system 100 may be the masked language model reward based on the second comparison between the masked training summary, the masked positive summary, and the masked negative summary. The second comparison, for example, may include a first distance between the masked positive summary and the masked training summary divided by a second distance between the masked negative summary and the masked training summary.

In some embodiments, the process 1100 includes, at step/operation 1110, generating a second reward metric based on a sentence-level reward and the masked language model reward. For example, the computing system 100 may generate the second reward metric based on the sentence-level reward and the masked language model reward. For instance, the second reward metric may include a weighted sum between the first comparison and the second comparison.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method, the computer-implemented method comprising generating, by one or more processors and using a machine learning model, a training summary for a training transcript; generating, by the one or more processors, a first reward metric for the machine learning model based on a comparison between the training summary and a target summary corresponding to the training transcript; generating, by the one or more processors, a second reward metric for the machine learning model based on the training summary, a positive summary, and a negative summary; generating, by the one or more processors, a third reward metric for the machine learning model based on one or more training key phrases from the training summary; generating, by the one or more processors, an aggregated reward metric based on one or more of the first reward metric, the second reward metric, or the third reward metric; and initiating, by the one or more processors, the performance of one or more training operations for the machine learning model based on the aggregated reward metric.

Example 2. The computer-implemented method of example 1, further comprising generating, using a supervised loss function, an initial weight set for the machine learning model; and generating the training summary based on the initial weight set.

Example 3. The computer-implemented method of example 2, wherein the initial weight set is generated during an initialization phase of the machine learning model and, during the initialization phase, the machine learning model is a first branch of one or more branches in a branched initialization neural architecture, and wherein generating the initial weight set comprises generating, using the first branch, an initializing summary for an initializing transcript; generating, using a second branch of the one or more branches, a topic classification for the initializing summary; generating, using a third branch of the one or more branches, one or more key phrases for the initializing summary; generating one or more of (i) a first initialization loss metric based on a comparison between the initializing summary and an initializing target summary corresponding to the initializing transcript, (ii) a second initialization loss metric based on a comparison between the topic classification and a target topic classification corresponding to the initializing transcript, or (iii) a third initialization loss metric based on a comparison between the one or more key phrases and a key phrase dataset corresponding to a target prediction domain; and generating, using a loss minimization function, the initial weight set based on an aggregated initialization loss metric comprising a weighted sum of one or more of the first initialization loss metric, the second initialization loss metric, or the third initialization loss metric.

Example 4. The computer-implemented method of example 3, wherein the initializing transcript is one of a plurality of initializing transcripts for a training dataset that corresponds to the target prediction domain and the machine learning model is previously trained for a nontarget prediction domain different from the target prediction domain.

Example 5. The computer-implemented method of any of the preceding examples, wherein the machine learning model is a first branch of a branched training neural architecture comprising the first branch, a second branch, and a third branch, wherein the second branch and the third branch respectively comprise one or more pretrained machine learning models.

Example 6. The computer-implemented method of example 5, wherein the one or more training key phrases are generated by the third branch of the branched training neural architecture and the third reward metric is based on a comparison between the one or more training key phrases and one or more target key phrases generated by the third branch of the branched training neural architecture for the target summary.

Example 7. The computer-implemented method of any of examples 5 or 6, wherein generating the first reward metric comprises generating a masked training summary for the training summary and a masked target summary for the target summary; generating a first discrete probability distribution for the masked training summary and a second discrete probability distribution for the masked target summary; and generating the first reward metric based on a distance between the first discrete probability distribution and the second discrete probability distribution.

Example 8. The computer-implemented method of example 7, wherein the distance is a Fisher-Rao distance.

Example 9. The computer-implemented method of any of examples 5 through 8, wherein the second branch comprises a machine learning sentence-level transformer and a machine learning masked language model and wherein generating the second reward metric comprises generating, using the machine learning sentence-level transformer, a training embedding for the training summary, a positive embedding for the positive summary, and a negative embedding for the negative summary; generating a sentence-level reward based on a first comparison between the positive embedding, the negative embedding, and the training embedding; generating, using the machine learning masked language model, a masked training summary for the training summary, a masked positive summary for the positive summary, and a masked negative summary for the negative summary; generating masked language model reward based on a second comparison between the masked training summary, the masked positive summary, and the masked negative summary; and generating the second reward metric based on the sentence-level reward and the masked language model reward.

Example 10. The computer-implemented method of example 9, wherein (i) the first comparison comprises a first cosine similarity between the positive embedding and the training embedding divided by a second cosine similarity between the negative embedding and the training embedding, and (ii) the second comparison comprises a first distance between the masked positive summary and the masked training summary divided by a second distance between the masked negative summary and the masked training summary.

Example 11. The computer-implemented method of any of examples 9 or 10, wherein the second reward metric comprises a weighted sum between the first comparison and the second comparison.

Example 12. The computer-implemented method of any of the preceding examples, wherein the one or more training operations comprise modifying a weight set of the machine learning model to generate an optimized weight set.

Example 13. A computing system comprising memory and one or more processors communicatively coupled to the memory, the one or more processors configured to generate, using a machine learning model, a training summary for a training transcript; generate a first reward metric for the machine learning model based on a comparison between the training summary and a target summary corresponding to the training transcript; generate a second reward metric for the machine learning model based on the training summary, a positive summary, and a negative summary; generate a third reward metric for the machine learning model based on one or more training key phrases from the training summary; generate aggregated reward metric based on one or more of the first reward metric, the second reward metric, or the third reward metric; and initiate the performance of one or more training operations for the machine learning model based on the aggregated reward metric.

Example 14. The computing system of example 13, wherein the one or more processors are further configured to generate, using a supervised loss function, an initial weight set for the machine learning model; and generate the training summary based on the initial weight set.

Example 15. The computing system of example 14, wherein the initial weight set is generated during an initialization phase of the machine learning model and, during the initialization phase, the machine learning model is a first branch of one or more branches in a branched initialization neural architecture, and wherein generating the initial weight set comprises generate, using the first branch, an initializing summary for an initializing transcript; generate, using a second branch of the one or more branches, a topic classification for the initializing summary; generate, using a third branch of the one or more branches, one or more key phrases for the initializing summary; generate one or more of (i) a first initialization loss metric based on a comparison between the initializing summary and an initializing target summary corresponding to the initializing transcript, (ii) a second initialization loss metric based on a comparison between the topic classification and a target topic classification corresponding to the initializing transcript, or (iii) a third initialization loss metric based on a comparison between the one or more key phrases and a key phrase dataset corresponding to a target prediction domain; and generate, using a loss minimization function, the initial weight set based on an aggregated initialization loss metric comprising a weighted sum of one or more of the first initialization loss metric, the second initialization loss metric, or the third initialization loss metric.

Example 16. The computing system of example 15, wherein the initializing transcript is one of a plurality of initializing transcripts for a training dataset that corresponds to the target prediction domain and the machine learning model is previously trained for a nontarget prediction domain different from the target prediction domain.

Example 17. One or more non-transitory computer-readable storage media including instructions that, when executed by one or more processors, cause the one or more processors to generate, using a machine learning model, a training summary for a training transcript; generate a first reward metric for the machine learning model based on a comparison between the training summary and a target summary corresponding to the training transcript; generate a second reward metric for the machine learning model based on the training summary, a positive summary, and a negative summary; generate a third reward metric for the machine learning model based on one or more training key phrases from the training summary; generate aggregated reward metric based on one or more of the first reward metric, the second reward metric, or the third reward metric; and initiate the performance of one or more training operations for the machine learning model based on the aggregated reward metric.

Example 18. The one or more non-transitory computer-readable storage media of example 17, wherein the machine learning model is a first branch of a branched training neural architecture comprising the first branch, a second branch, and a third branch, wherein the second branch and the third branch respectively comprise one or more pretrained machine learning models.

Example 19. The one or more non-transitory computer-readable storage media of example 18, wherein the one or more training key phrases are generated by the third branch of the branched training neural architecture and the third reward metric is based on a comparison between the one or more training key phrases and one or more target key phrases generated by the third branch of the branched training neural architecture for the target summary.

Example 20. The one or more non-transitory computer-readable storage media of any of examples 18 or 19, wherein generating the first reward metric comprises generating a masked training summary for the training summary and a masked target summary for the target summary; generating a first discrete probability distribution for the masked training summary and a second discrete probability distribution for the masked target summary; and generating the first reward metric based on a distance between the first discrete probability distribution and the second discrete probability distribution.

1. A computer-implemented method, the computer-implemented method comprising:
generating, by one or more processors and using a machine learning model, a training summary for a training transcript;
generating, by the one or more processors, a first reward metric for the machine learning model based on a comparison between the training summary and a target summary corresponding to the training transcript;
generating, by the one or more processors, a second reward metric for the machine learning model based on the training summary, a positive summary, and a negative summary;
generating, by the one or more processors, a third reward metric for the machine learning model based on one or more training key phrases from the training summary;
generating, by the one or more processors, an aggregated reward metric based on one or more of the first reward metric, the second reward metric, or the third reward metric; and
initiating, by the one or more processors, the performance of one or more training operations for the machine learning model based on the aggregated reward metric.

2. The computer-implemented method of claim 1, further comprising:
generating, using a supervised loss function, an initial weight set for the machine learning model; and
generating the training summary based on the initial weight set.

3. The computer-implemented method of claim 2, wherein the initial weight set is generated during an initialization phase of the machine learning model and, during the initialization phase, the machine learning model is a first branch of one or more branches in a branched initialization neural architecture, and wherein generating the initial weight set comprises:
generating, using the first branch, an initializing summary for an initializing transcript;
generating, using a second branch of the one or more branches, a topic classification for the initializing summary;
generating, using a third branch of the one or more branches, one or more key phrases for the initializing summary;
generating one or more of (i) a first initialization loss metric based on a comparison between the initializing summary and an initializing target summary corresponding to the initializing transcript, (ii) a second initialization loss metric based on a comparison between the topic classification and a target topic classification corresponding to the initializing transcript, or (iii) a third initialization loss metric based on a comparison between the one or more key phrases and a key phrase dataset corresponding to a target prediction domain; and
generating, using a loss minimization function, the initial weight set based on an aggregated initialization loss metric comprising a weighted sum of one or more of the first initialization loss metric, the second initialization loss metric, or the third initialization loss metric.

4. The computer-implemented method of claim 3, wherein the initializing transcript is one of a plurality of initializing transcripts for a training dataset that corresponds to the target prediction domain and the machine learning model is previously trained for a nontarget prediction domain different from the target prediction domain.

5. The computer-implemented method of claim 1, wherein the machine learning model is a first branch of a branched training neural architecture comprising the first branch, a second branch, and a third branch, wherein the second branch and the third branch respectively comprise one or more pretrained machine learning models.

6. The computer-implemented method of claim 5, wherein the one or more training key phrases are generated by the third branch of the branched training neural architecture and the third reward metric is based on a comparison between the one or more training key phrases and one or more target key phrases generated by the third branch of the branched training neural architecture for the target summary.

7. The computer-implemented method of claim 5, wherein generating the first reward metric comprises:
generating a masked training summary for the training summary and a masked target summary for the target summary;
generating a first discrete probability distribution for the masked training summary and a second discrete probability distribution for the masked target summary; and
generating the first reward metric based on a distance between the first discrete probability distribution and the second discrete probability distribution.

8. The computer-implemented method of claim 7, wherein the distance is a Fisher-Rao distance.

9. The computer-implemented method of claim 5, wherein the second branch comprises a machine learning sentence-level transformer and a machine learning masked language model and wherein generating the second reward metric comprises:
generating, using the machine learning sentence-level transformer, a training embedding for the training summary, a positive embedding for the positive summary, and a negative embedding for the negative summary;
generating a sentence-level reward based on a first comparison between the positive embedding, the negative embedding, and the training embedding;
generating, using the machine learning masked language model, a masked training summary for the training summary, a masked positive summary for the positive summary, and a masked negative summary for the negative summary;
generating masked language model reward based on a second comparison between the masked training summary, the masked positive summary, and the masked negative summary; and
generating the second reward metric based on the sentence-level reward and the masked language model reward.

10. The computer-implemented method of claim 9, wherein (i) the first comparison comprises a first cosine similarity between the positive embedding and the training embedding divided by a second cosine similarity between the negative embedding and the training embedding, and (ii) the second comparison comprises a first distance between the masked positive summary and the masked training summary divided by a second distance between the masked negative summary and the masked training summary.

11. The computer-implemented method of claim 9, wherein the second reward metric comprises a weighted sum between the first comparison and the second comparison.

12. The computer-implemented method of claim 1, wherein the one or more training operations comprise modifying a weight set of the machine learning model to generate an optimized weight set.

13. A computing system comprising memory and one or more processors communicatively coupled to the memory, the one or more processors configured to:
generate, using a machine learning model, a training summary for a training transcript;
generate a first reward metric for the machine learning model based on a comparison between the training summary and a target summary corresponding to the training transcript;
generate a second reward metric for the machine learning model based on the training summary, a positive summary, and a negative summary;
generate a third reward metric for the machine learning model based on one or more training key phrases from the training summary;
generate aggregated reward metric based on one or more of the first reward metric, the second reward metric, or the third reward metric; and
initiate the performance of one or more training operations for the machine learning model based on the aggregated reward metric.

14. The computing system of claim 13, wherein the one or more processors are further configured to:
generate, using a supervised loss function, an initial weight set for the machine learning model; and
generate the training summary based on the initial weight set.

15. The computing system of claim 14, wherein the initial weight set is generated during an initialization phase of the machine learning model and, during the initialization phase, the machine learning model is a first branch of one or more branches in a branched initialization neural architecture, and wherein generating the initial weight set comprises:
generate, using the first branch, an initializing summary for an initializing transcript;
generate, using a second branch of the one or more branches, a topic classification for the initializing summary;
generate, using a third branch of the one or more branches, one or more key phrases for the initializing summary;
generate one or more of (i) a first initialization loss metric based on a comparison between the initializing summary and an initializing target summary corresponding to the initializing transcript, (ii) a second initialization loss metric based on a comparison between the topic classification and a target topic classification corresponding to the initializing transcript, or (iii) a third initialization loss metric based on a comparison between the one or more key phrases and a key phrase dataset corresponding to a target prediction domain; and
generate, using a loss minimization function, the initial weight set based on an aggregated initialization loss metric comprising a weighted sum of one or more of the first initialization loss metric, the second initialization loss metric, or the third initialization loss metric.

16. The computing system of claim 15, wherein the initializing transcript is one of a plurality of initializing transcripts for a training dataset that corresponds to the target prediction domain and the machine learning model is previously trained for a nontarget prediction domain different from the target prediction domain.

17. One or more non-transitory computer-readable storage media including instructions that, when executed by one or more processors, cause the one or more processors to:
generate, using a machine learning model, a training summary for a training transcript;
generate a first reward metric for the machine learning model based on a comparison between the training summary and a target summary corresponding to the training transcript;
generate a second reward metric for the machine learning model based on the training summary, a positive summary, and a negative summary;
generate a third reward metric for the machine learning model based on one or more training key phrases from the training summary;
generate aggregated reward metric based on one or more of the first reward metric, the second reward metric, or the third reward metric; and
initiate the performance of one or more training operations for the machine learning model based on the aggregated reward metric.

18. The one or more non-transitory computer-readable storage media of claim 17, wherein the machine learning model is a first branch of a branched training neural architecture comprising the first branch, a second branch, and a third branch, wherein the second branch and the third branch respectively comprise one or more pretrained machine learning models.

19. The one or more non-transitory computer-readable storage media of claim 18, wherein the one or more training key phrases are generated by the third branch of the branched training neural architecture and the third reward metric is based on a comparison between the one or more training key phrases and one or more target key phrases generated by the third branch of the branched training neural architecture for the target summary.

20. The one or more non-transitory computer-readable storage media of claim 18, wherein generating the first reward metric comprises:
generating a masked training summary for the training summary and a masked target summary for the target summary;
generating a first discrete probability distribution for the masked training summary and a second discrete probability distribution for the masked target summary; and
generating the first reward metric based on a distance between the first discrete probability distribution and the second discrete probability distribution.
